(19) United States
(12) Patent Application Publication
(10) Pub. No.: US 2017/0206143 A1
(43) Pub. Date: Jul. 20, 2017

(54) MANAGEMENT APPARATUS, MANAGEMENT METHOD, AND COMPUTER-READABLE RECORDING MEDIUM RECORDED WITH MANAGEMENT PROGRAM

(71) Applicant: FUJITSU LIMITED, Kawasaki-shi (JP)

(72) Inventors: Keiichi Ohmachi, Setagaya (JP); TSUYOSHI OKUMURA, Kawasaki (JP); Takahiro ARAKAWA, Machida (JP); DAISUKE HOSHI, Kawasaki (JP); Mai Izawa, Ota (JP); Yuhei Nomura, Kawasaki (JP)

(73) Assignee: FUJITSU LIMITED, Kawasaki-shi (JP)

(21) Appl. No.: 15/406,816

(22) Filed: Jan. 16, 2017

(30) Foreign Application Priority Data
Jan. 19, 2016 (JP) 2016-007966

(51) Int. Cl. G06F 11/14; G06F 9/455

(52) U.S. Cl. CPC G06F 11/1458; G06F 11/1448; G06F 9/45558; G06F 2201/84; G06F 2201/815; G06F 2009/45595; G06F 2009/45583

(57) ABSTRACT

A management apparatus includes a determination unit configured to determine a relationship state between a plurality of snapshots, a setting unit configured to set importance level information for each snapshot on the basis of the relationship state determined, and a deletion processing unit configured to preferentially delete a snapshot of which importance level information is the lowest, so that a snapshot of which importance level is low can be easily determined from among the plurality of snapshots.

### CROSS-REFERENCE TO RELATED APPLICATION

This application is based upon and claims the benefit of priority of the prior Japanese Patent application No. 2016-7966, filed on Jan. 19, 2016, the entire contents of which are incorporated herein by reference.

### FIELD

The embodiment discussed herein is directed to a management apparatus, a management method, and a computer-readable recording medium recorded with a management program.

### BACKGROUND

SEs (Software Engineers) and verifiers (hereinafter referred to as workers) who are in charge of structuring and verifying of an IT (Information technology) infrastructure system obtain snapshots of the system in units of detailed operations in order to cope with situations of erroneous operations, specification changes, and errors that occur frequently in each device.

The snapshot saves a state of a virtual system and the like at any given point in time, and when this snapshot is used, the virtual machine can roll back to the any given state.

For example, when an IT infrastructure is structured, first, a snapshot (1) is obtained, and structuring work (1) is performed.

Then, in a case where there occurs an erroneous operation, a design change, or an error, the virtual machine can roll back to the state before the structuring work (1) was performed, i.e., the state at which the snapshot (1) was obtained, by applying this snapshot (1). In a case where there does not occur any erroneous operation, design change, or error, a snapshot (2) is obtained, and a subsequent structuring work (2) is performed. In a case where there does not occur any problem in the structuring work, acquisition of subsequent snapshots and structuring works are repeatedly performed.

On the other hand, in a case where there occurs an erroneous operation, design, or change error, a previous snapshot to which the virtual machine rolls back is selected, and the snapshot is applied, so that the virtual machine rolls back to the state before the structuring work, which caused the occurrence of the problem, was performed.

Structuring works may be performed with multiple virtual machines. For example, in a case where structuring works are performed with two virtual machines V1, V2, first, a snapshot (1) is obtained in the virtual machine V1, and subsequently, a snapshot (2) is obtained in the virtual machine V2. A structuring work (1) is performed with the virtual machine V1, and a structuring work (2) is performed with the virtual machine V2.

In this case, in a case where there occurs an operation, a design change, or an error, the snapshot (1) is applied to the virtual machine V1, and the snapshot (2) is applied to the virtual machine V2, so that the virtual machine rolls back to the state before the structuring work, which caused the occurrence of the problem, was performed.

On the other hand, in a case where there does not occur any erroneous operation, design change, or error, a snapshot (3) is obtained in the virtual machine V1, and a snapshot (4) is obtained in the virtual machine V2.

Thereafter, for example, information is registered from the virtual machine V2 to the virtual machine V1. In this case, in a case where there occurs an erroneous operation, a design change, or an error, an occurrence of an error in the virtual machine V2 is notified to the virtual machine V1. Accordingly, an investigation of a cause is performed with each of the virtual machines V1, V2.

In order to recover the system, the worker determines which snapshot from among multiple snapshots obtained in each of the virtual machines V1, V2 is to roll back to and apply the determined snapshot.

By the way, the number of snapshots that can be obtained in a single virtual machine (upper limit number) is limited. For example, in Windows (registered trademark), the upper limit number of snapshots per virtual machine is 50, and in VMware (registered trademark), the upper limit number of snapshots per virtual machine is 32.

When the number of obtained snapshots (obtained number) reaches the upper limit, the worker needs to delete snapshots.
Patent Document 1: JP 2010-92177 A
Patent Document 2: JP 2012-243039 A
Patent Document 3: JP 5713138 B1

As described above, in a case where the number of obtained snapshots reaches the upper limit, the worker needs to delete snapshots, but in a conventional information processing apparatus, snapshots to be deleted are selected on the basis of worker's experience. For this reason, the worker may delete important snapshots that are not to be deleted by mistake.

In a case where snapshots are deleted by mistake because of reasons such as erroneous selection, erroneous operation, and the like, there is no choice but to apply a snapshot obtained further before the deleted snapshot. Therefore, the system rolls back to the state when this snapshot was obtained, and the structuring work and the like that has been performed is wasted.

In a case where structuring works are performed with multiple virtual machines, there arises the following problem. When multiple virtual machines are related to each other, and an important snapshot of any given virtual machine is deleted by mistake, a snapshot obtained further before the deleted snapshot is to be applied to the other virtual machine.

Therefore, as a result, the system rolls back to the state when this snapshot was obtained, and the structuring work and the like that has been performed is wasted.

### SUMMARY

According to an aspect of the embodiments, this management apparatus is a management apparatus for managing a plurality of snapshots stored in a storage apparatus, the management apparatus including: a determination unit configured to determine a relationship state between the plurality of snapshots; a setting unit configured to set importance level information for each snapshot on the basis of the relationship state determined; and a deletion processing unit configured to preferentially delete a snapshot of which importance level information is the lowest.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a figure schematically illustrating a configuration of an information processing system serving as an example of an embodiment;

FIG. 2 is a functional configuration diagram illustrating an information processing system serving as an example of an embodiment;

FIG. 3 is a functional configuration diagram illustrating a management server of an information processing system serving as an example of an embodiment;

FIGS. 4A to 4D are figures illustrating an example of a log from an operation server in an information processing system serving as an example of an embodiment;

FIG. 5 is a figure illustrating an example of an elapsed time between snapshots;

FIG. 6 is a figure for explaining a relationship between a structuring work and a snapshot;

FIG. 7 is a figure illustrating an example of a tree structure of snapshots;

FIG. 8 is a figure illustrating an example of a tree structure of snapshots;

FIGS. 9A and 9B are figures for explaining a determination method for determining whether there is a dependency relationship or not on the basis of repetition of acquisition of snapshots in multiple virtual machines;

FIGS. 10A and 10B are figures for explaining a determination method for determining whether there is a dependency relationship or not on the basis of whether reboot is performed simultaneously in multiple virtual machines;

FIGS. 11A and 11B are figures for explaining a determination method for determining whether there is a dependency relationship or not on the basis of IP addresses of event logs in multiple virtual machines;

FIGS. 12A and 12B are figures for explaining a determination method for determining whether there is a dependency relationship or not on the basis of category contents in event logs in multiple virtual machines;

FIG. 13 is a figure illustrating an example of importance level addition point information T1 used by a snapshot calculation unit of an information processing system serving as an example of an embodiment;

FIG. 14 is a figure illustrating an example of importance level addition point information T2 used by a snapshot calculation unit of an information processing system serving as an example of an embodiment;

FIG. 15 is a figure illustrating an example of importance level addition point information T3 used by a snapshot calculation unit of an information processing system serving as an example of an embodiment;

FIG. 16 is a figure illustrating an example of importance level point information T4 used by a snapshot calculation unit of an information processing system serving as an example of an embodiment;

FIG. 17 is a flowchart for explaining an overview of processing of a snapshot importance level determination unit of an information processing system serving as an example of an embodiment;

FIG. 18 is a flowchart for explaining processing of an event determination unit of an information processing system serving as an example of an embodiment;

FIG. 19 is a flowchart for explaining processing of a controller unit of an information processing system serving as an example of an embodiment;

FIG. 20 is a flowchart for explaining processing of a log obtaining unit of an information processing system serving as an example of an embodiment;

FIG. 21 is a flowchart for explaining processing on the basis of a relationship property of multiple snapshots formed in any given virtual machine with a log analysis unit of an information processing system serving as an example of an embodiment;

FIG. 22 is a flowchart for explaining processing on the basis of a relationship property of multiple snapshots formed in multiple virtual machines with a log analysis unit of an information processing system serving as an example of an embodiment;

FIG. 23 is a flowchart for explaining processing with a snapshot calculation unit of an information processing system serving as an example of an embodiment;

FIG. 24 is a flowchart for explaining processing of a snapshot calculation unit of an information processing system serving as an example of an embodiment;

FIG. 25 is a flowchart for explaining processing of a snapshot operation unit of an information processing system 1 serving as an example of an embodiment;

FIG. 26 is a figure illustrating an example of information about each snapshot constituting a snapshot tree;

FIG. 27 is a sequence diagram illustrating an example where acquisition of snapshots is repeated in multiple virtual machines;

FIG. 28 is a figure illustrating an example of addition points set for snapshots;

FIG. 29 is a sequence diagram illustrating an example where reboot is performed simultaneously in multiple virtual machines;

FIG. 30 is a figure illustrating an example of addition points which are set for snapshots;

FIG. 31 is a sequence diagram illustrating an example where multiple virtual machines output IP addresses of each other in OS event logs;

FIG. 32 is a figure illustrating an example of addition points which are set for snapshots;

FIG. 33 is a sequence diagram illustrating an example where the same category contents are included in OS event logs in multiple virtual machines;

FIG. 34 is a figure illustrating an example of addition points which are set for snapshots;

FIG. 35 is a sequence diagram illustrating an example where multiple dependency relationships are continuously detected in multiple virtual machines;

FIG. 36 is a figure illustrating an example of addition points which are set for snapshots; and

FIG. 37 is a figure illustrating an example of importance level point information T4.

### DESCRIPTION OF EMBODIMENTS

Embodiments according to a management apparatus, a management method, and a computer-readable recording medium recorded with a management program will be hereinafter explained with reference to drawings. However, embodiment illustrated below is merely examples, and it is not intended to exclude various kinds of modifications and applications of techniques not illustrated in the embodiment. More specifically, the present embodiment can be carried out by applying various kinds of modifications without deviating from the gist of the present embodiment. In addition, it is not to be understood that each drawing includes nothing but the constituent elements illustrated in the drawing, and other functions and the like may also be included.

### (A) Configuration

(A-1) Hardware Configuration

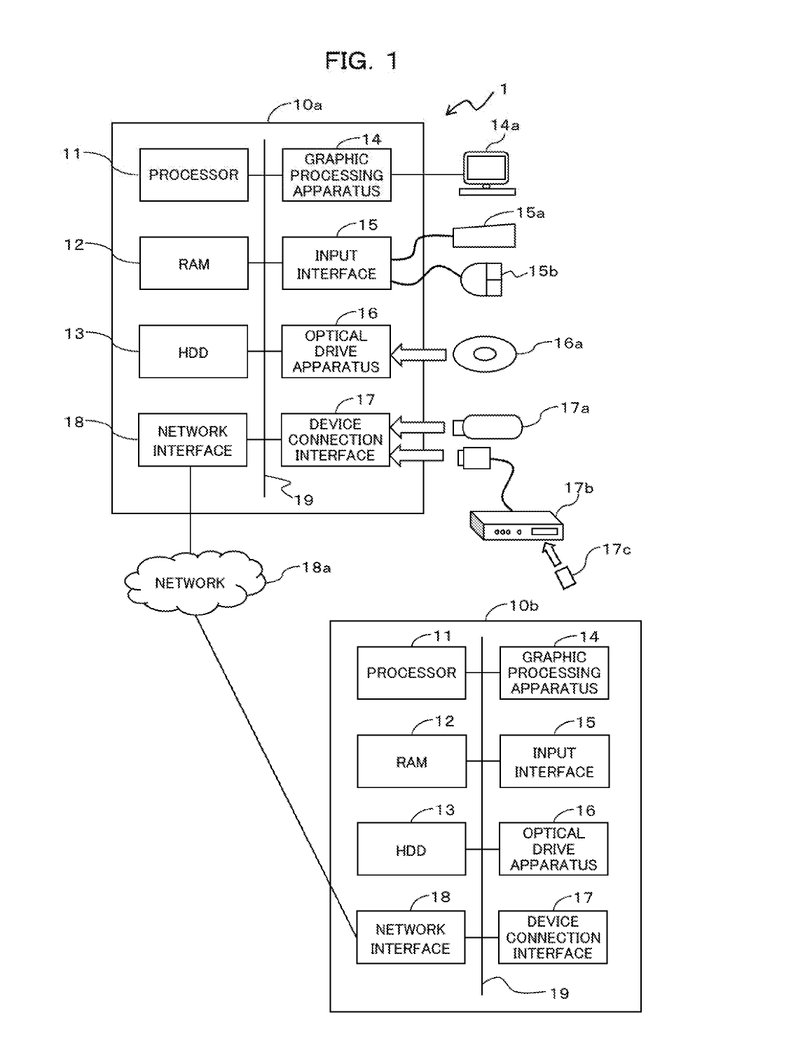

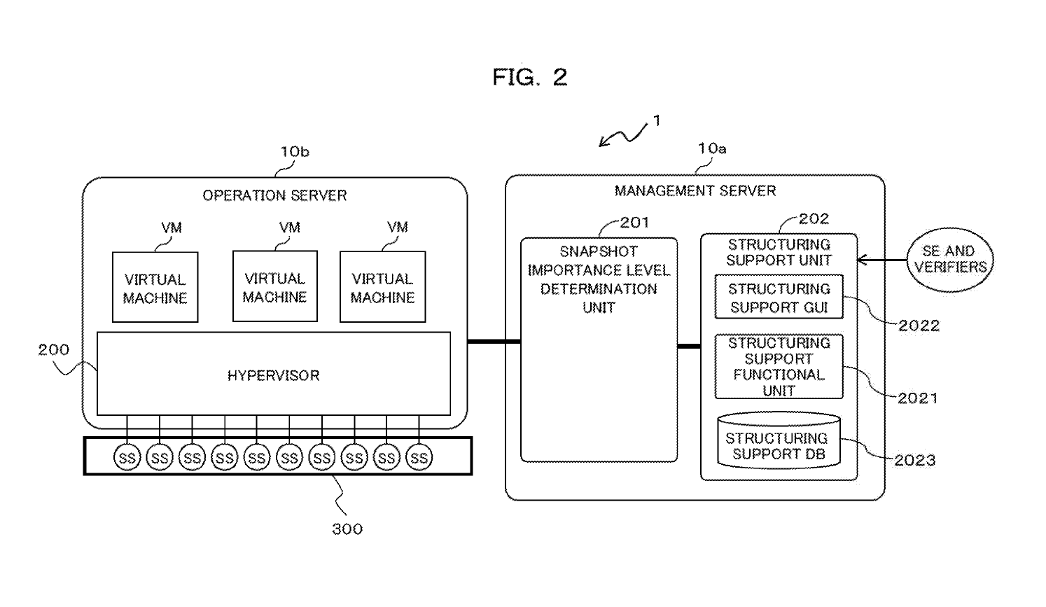

FIG. 1 is a figure schematically illustrating a configuration of the information processing system 1 serving as an example of an embodiment, and FIG. 2 is a functional configuration diagram thereof.

The information processing system 1 includes an operation server 10b and a management server 10a.

First, a hardware configuration of the information processing system 1 according to the present embodiment will be explained with reference to FIG. 1.

The operation server 10b and the management server 10a are computers (information processing apparatuses) having a similar configuration to each other. The same reference numerals denote similar portions.

Hereinafter, the operation server 10b and the management server 10a may be referred to as computers 10.

In the example as illustrated in FIG. 1, like the management server 10a, the operation server 10b is also provided with a monitor 14a, a keyboard 15a, a mouse 15b, an optical disk 16a, a memory apparatus 17a, a memory reader and writer 17b, and a memory card 17c, although they are not illustrated for the sake of convenience.

The computer 10 (the operation server 10b, the management server 10a) includes, as constituent elements, a processor 11, a RAM (Random Access Memory) 12, an HDD (Hard Disk Drive) 13, a graphic processing apparatus 14, an input interface 15, an optical drive apparatus 16, a device connection interface 17, and a network interface 18. These constituent elements 11 to 18 are configured to be able to communicate with each other via a bus 19.

The processor (processing unit) 11 controls the entire computer 10. The processor 11 may be a multiprocessor. The processor 11 may be any one of, for example, a CPU (Central Processing Unit), an MPU (Micro Processing Unit), a DSP (Digital Signal Processor), an ASIC (Application Specific Integrated Circuit), a PLD (Programmable Logic Device), and an FPGA (Field Programmable Gate Array). The processor 11 may be a combination of two or more types of elements including a CPU, an MPU, a DSP, an ASIC, a PLD, and an FPGA.

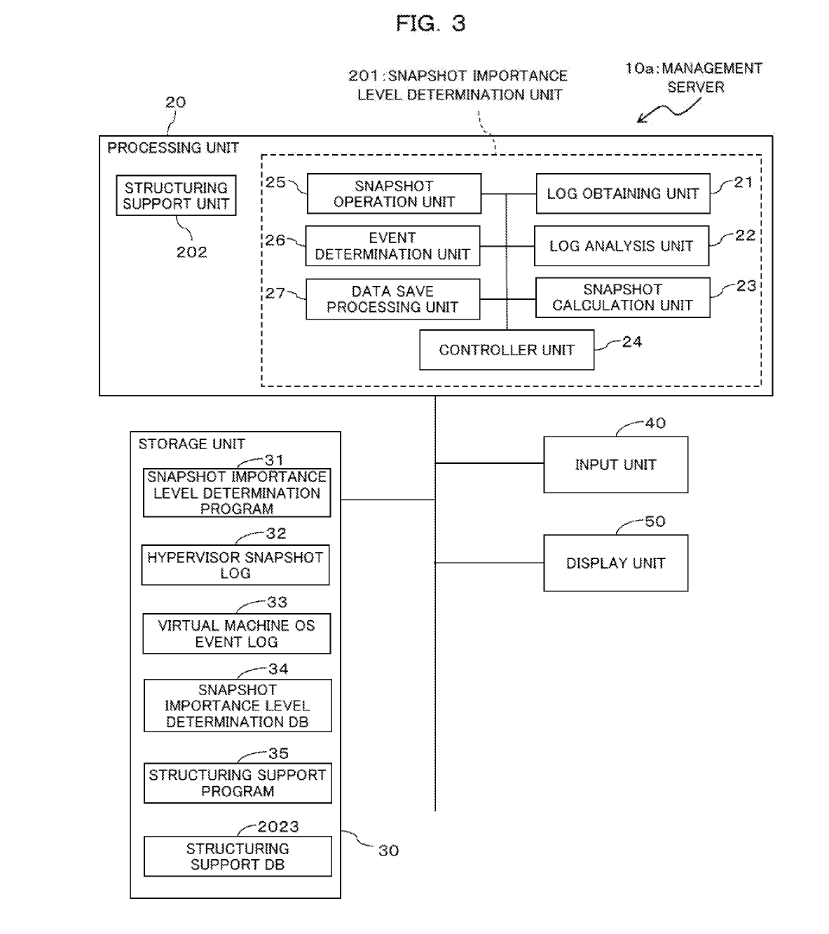

The RAM (storage unit) 12 is used as a main storage apparatus of the computer 10. The RAM 12 temporarily stores at least a part of an OS (Operating System) program and an application program executed by the processor 11. The RAM 12 also stores various kinds of data required for processing performed with the processor 11. The application program may include a snapshot importance level determination program 31 (see FIG. 3) executed by the processor 11 in order to realize a snapshot importance level determination function according to the present embodiment with the computer 10.

The HDD (storage unit) 13 magnetically writes and reads data to and from an internal disk. The HDD 13 is used as an auxiliary storage apparatus for the computer 10. The HDD 13 stores an OS program, an application program, and various kinds of data. The auxiliary storage apparatus may be a semiconductor storage apparatus (SSD: Solid State Drive) such as a flash memory.

The graphic processing apparatus 14 is connected to the monitor 14a. The graphic processing apparatus 14 displays an image on a screen of the monitor 14a in accordance with a command given by the processor 11. The monitor 14a may be a display apparatus using a CRT (Cathode Ray Tube), a liquid crystal display apparatus, and the like.

The input interface 15 is connected to the keyboard 15a and the mouse 15b. The input interface 15 transmits a signal sent from the keyboard 15a and the mouse 15b to the processor 11. The mouse 15b is an example of a pointing device, and other pointing devices may also be used. Examples of other pointing devices include a touch panel, a tablet, a touchpad, a trackball, and the like.

The optical drive apparatus 16 uses laser light and the like to read data recorded on the optical disk 16a. The optical disk 16a is a portable non-transitory recording medium recorded with data in such a manner that the data can be read with reflection of light. The optical disk 16a may be, for example, a DVD (Digital Versatile Disc), a DVD-RAM, a CD-ROM (Compact Disc Read Only Memory), a CD-R (Recordable)/RW (ReWritable), and the like.

The device connection interface 17 is a communication interface for connecting a peripheral device with the computer 10. For example, the device connection interface 17 can be connected to the memory apparatus 17a and the memory reader and writer 17b. The memory apparatus 17a is a non-transitory recording medium provided with a communication function for communication with the device connection interface 17, for example, a USB (Universal Serial Bus) memory. The memory reader and writer 17b writes data to the memory card 17c, or reads data from the memory card 17c. The memory card 17c is a card-type non-transitory recording medium.

The network interface 18 is connected to the network 18a. The network interface 18 transmits and receives data to and from another computer or a communication device via the network 18a.

In the operation server 10b (computer 10) having the above hardware configuration, a hypervisor 200 (see FIG. 2) is executed by, for example, a program recorded in a computer-readable non-transitory recording medium. Then, one or more virtual machines (VMs) are executed on this hypervisor 200.

On the other hand, in the management server 10a (computer 10) having the above hardware configuration, a snapshot importance level determination function according to the present embodiment is realized by, for example, executing a program recorded on a computer-readable non-transitory recording medium. A program describing a processing content, which is to be executed by the computer 10, can be recorded on various recording media. For example, a program, which is to be executed by the computer 10, can be stored to the HDD 13. The processor 11 loads at least a portion of the program in the HDD 13 to the RAM 12, and executes the loaded program.

A program, which is to be executed by the computer 10 (processor 11), may be recorded on a non-transitory portable recording medium such as an optical disk 16a, a memory apparatus 17a, a memory card 17c, and the like. The program stored in the portable recording medium can be executed after it is installed to the HDD 13 in accordance with, for example, control performed with the processor 11. The processor 11 can directly read the program from the portable recording medium and execute the program.

(A-2) Functional Configuration

First, a configuration of the information processing system 1 according to the present embodiment will be explained with reference to FIG. 2.

(A-2-1) Operation Server

The operation server 10b executes the hypervisor (Hypervisor) 200, so that one or more virtual machines (three virtual machines in the example as illustrated in FIG. 2) are executed on this hypervisor 200.

In the operation server 10b, the processor 11 executes the hypervisor 200 to operate one or more virtual machines.

The hypervisor 200 is software for virtualizing the computer to enable multiple virtual machines to be executed in parallel. The hypervisor 200 makes one or more virtual machines, so that various kinds of OSes operate on each virtual machine.

The virtual machine is a virtual computer generated on the hypervisor 200. Like a computer realized with physical hardware, each virtual machine executes various kinds of processing by using a peripheral device such as BIOS (Basic Input Output System), a CPU, a memory, a disk, a keyboard, a mouse, a CD-ROM drive, and the like. For example, the virtual machine executes various kinds of OSes.

The operation server 10b has a storage apparatus 300, and multiple snapshots (SS) obtained with regard to a virtual machine are stored to this storage apparatus 300. The storage apparatus 300 is a storage apparatus such as an HDD and an SSD, and is configured to store various kinds of data.

The snapshots obtained in the operation server 10b may be stored to a storage apparatus provided in the management server 10a, and can be embodied upon making various modifications.

(A-2-2) Management Server

The management server 10a is an apparatus for managing the operation server 10b. As illustrated in FIG. 2, the management server 10a has functions to serve as a structuring support unit 202 and a snapshot importance level determination unit 201.

As illustrated in FIG. 2, the structuring support unit 202 has functions to serve as a structuring support functional unit 2021, a structuring support GUI (Graphical User Interface) 2022, and a structuring support DB (Data Base) 2023.

The structuring support functional unit 2021 structures a virtual machine in the operation server 10b. The virtual machines can be realized in accordance with known methods, and the explanation thereabout is omitted.

The structuring support functional unit 2021 obtains snapshots in each virtual machine, and performs processing to apply (reapply) the obtained snapshots to the virtual machine. These acquisition and application of snapshots in these virtual machines can also be realized in accordance with known methods, and the explanation thereabout is omitted.

The structuring support functional unit 2021 collects various kinds of information about various kinds of apparatuses constituting virtual machines and structuring environments (for example, a switch, a storage, and the like not illustrated). For example, the structuring support functional unit 2021 records processing times and processing contents of each virtual machine. More specifically, the structuring support functional unit 2021 collects various kinds of logs of the hypervisor 200 and each virtual machine in the operation server 10b.

The structuring support functional unit 2021 obtains a tree structure state of snapshots obtained in virtual machines.

Multiple snapshots obtained in virtual machines may have relationship with each other in terms of chronological order and data structure. Such relationship of snapshots with each other can be expressed as a tree structure. The structuring support functional unit 2021 has functions for managing the tree structure state of such snapshots.

For example, the structuring support unit 202 obtains information about the tree structure of snapshots (for example, various kinds of information about a parent tree and a child tree, a child tree number, a branch tree number) by executing known commands for obtaining a list of snapshots by logging into the hypervisor 200.

The structuring support functional unit 2021 registers and deletes an account information of each device constituting the structuring environment. Further, the structuring support functional unit 2021 manages structuring works in detailed units for the structuring environment and statuses of the structuring works.

The structuring support GUI 2022 provides a GUI with which a worker performs various kinds of input operations to cause the structuring support unit 202 to achieve the functions. The worker performs various kinds of input operations and the like with the structuring support GUI 2022.

The structuring support DB 2023 saves and manages information obtained from each device constituting the structuring environment.

For example, the structuring support DB 2023 manages a device name, an IP (Internet Protocol) address, a user ID, a password, and the like for each device and the operation server 10b. The information is stored to the HDD 13 and the like of the management server 10a.

The functions for serving as the structuring support unit 202 (the structuring support functional unit 2021, the structuring support GUI 2022, and the structuring support DB 2023) are realized by causing the processor 11 of the management server 10a to execute a structuring support program 35 (see FIG. 3).

FIG. 3 explains a functional configuration of the management server 10a having the snapshot importance level determination function according to the present embodiment. In this FIG. 3, for the sake of convenience, the functions provided in the structuring support unit 202 are omitted.

The management server 10a achieves functions for serving as the snapshot importance level determination unit 201 for setting an importance level for a snapshot obtained in the operation server 10b. For this reason, as illustrated in FIG. 3, the management server 10a includes at least functions for serving as the processing unit 20, the storage unit 30, the input unit 40, and the display unit 50.

For example, the processing unit 20 is the processor 11 as illustrated in FIG. 1, and achieves functions for serving as the snapshot importance level determination unit 201 (a log obtaining unit 21, a log analysis unit 22, a snapshot calculation unit 23, a controller unit 24, a snapshot operation unit 25, an event determination unit 26, and a data save processing unit 27) explained later by executing the snapshot importance level determination program 31. The processing unit 20 (processor 11) achieves functions for serving as the structuring support unit 202 explained above by executing the structuring support program 35.

For example, the storage unit 30 is the RAM 12 and the HDD 13 as illustrated in FIG. 1, and stores and saves various kinds of information for realizing snapshot importance level determination functions. The various kinds of information include not only the snapshot importance level determination program 31 explained above, but also the hypervisor snapshot log 32, the virtual machine OS event log 33, a snapshot importance level determination DB 34, and the like.

The snapshot importance level determination DB 34 stores various kinds of information and the like used by the log analysis unit 22 and the snapshot calculation unit 23 explained later.

For example, the snapshot importance level determination DB 34 stores a date, a device name, and a content with regard to various kinds of logs and snapshots obtained in the operation server 10b (virtual machines).

As explained above, the storage unit 30 saves results of various kinds of analysis performed with the log analysis unit 22, the importance level point information T4 made by the snapshot calculation unit 23, and the like.

Further, the snapshot importance level determination DB 34 stores the importance level addition point information T1 to T3 explained later.

The storage unit 30 stores and saves the structuring support program 35 and the structuring support DB 2023 explained above.

For example, the input unit 40 is the keyboard 15a and the mouse 15b as illustrated in FIG. 1, and the user operates the input unit 40 to give various kinds of commands and perform information input. Instead of the mouse 15b, it may also be possible to use a touch panel, a tablet, a touchpad, a trackball, and the like.

For example, the display unit 50 is the monitor 14a as illustrated in FIG. 1, and when the user performs various kinds of operation input by using the computer 10 according to the present embodiment, the display unit 50 displays various kinds of information and messages.

The snapshot importance level determination program 31 is configured to cause the processing unit 20 (processor 11) to execute processing performed with the log obtaining unit 21, log analysis unit 22, snapshot calculation unit 23, controller unit 24, snapshot operation unit 25, data save processing unit 27, and event determination unit 26, explained later.

Therefore, as illustrated in FIG. 3, the management server 10a has functions for serving as at least the log obtaining unit 21, the log analysis unit 22, the snapshot calculation unit 23, the controller unit 24, the snapshot operation unit 25, the data save processing unit 27, and the event determination unit 26.

The log obtaining unit 21 obtains a device list constituting a system structure from the structuring support unit 202 (structuring support functional unit 2021), and collects logs from each device (the hypervisor 200 and each virtual machine) constituting the structuring environments. Hereinafter, the hypervisor 200 and each virtual machine may be referred to as each device.

The log obtaining unit 21 may collect logs from not only the hypervisor 200 and each virtual machine explained above but also switches, the operation server 10b, storages, and the like. More specifically, “each device” may include switches, the operation server 10b, storages, and the like.

For example, the log obtaining unit 21 requests the structuring support unit 202 to collect device information, so that the device information is obtained. The log obtaining unit 21 also gives the obtained information to the controller unit 24.

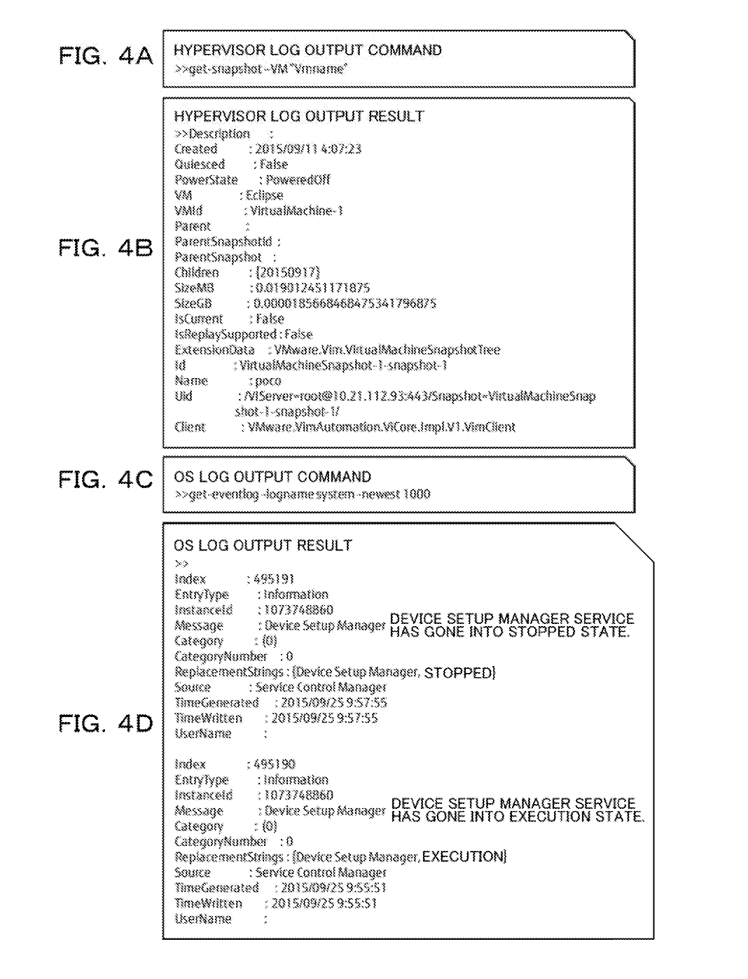

FIGS. 4A to 4D are figures illustrating an example of a log given by the operation server 10b in the information processing system 1 serving as an example of an embodiment. In FIGS. 4A to 4D, reference symbol (a) illustrates a command example for outputting a log of the hypervisor 200, and reference symbol (b) illustrates a log output result example of the hypervisor 200. Reference symbol (c) illustrates a command example for outputting a log of an OS, and reference symbol (d) illustrates a log output result example of the OS.

In FIGS. 4A to 4D, as illustrated in reference symbol (a), the log obtaining unit 21 executes, for example, a command “get-snapshot-VM ‘VM name’”, so that a log of the hypervisor 200 (hypervisor log) as illustrated in reference symbol (b) can be obtained. In the above command, “VM name” is substituted with a name for identifying the virtual machine (VM name).

Logs of virtual machines, logs of snapshots thereof, and the like can be obtained from the hypervisor log. The logs of the snapshots include, for example, a creation date and time (Created), information about a parent child relationship for forming a snapshot tree (Present/Children), and the like.

As indicated by reference symbol (c), when the log obtaining unit 21 executes, for example, a command “get-eventlog-logname system-newest 1000”, a log of the OS (OS event log) as indicated by reference symbol (d) can be obtained.

The OS event log as indicated by reference symbol (d) is a log of events that occurred in the OS (event log), and the OS event log includes, for example, an execution start date and time and a stop date and time of a service of the OS (Device Setup Manager service in the example of FIGS. 4A to 4D), and the OS event log includes a content of an output message (Message) and the like.

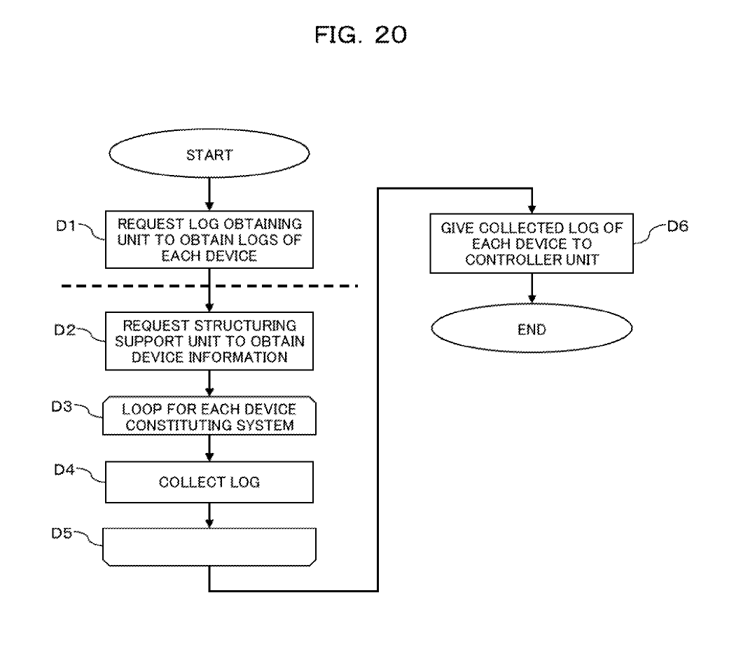

The details of the processing performed by the log obtaining unit 21 will be explained with reference to a flowchart as illustrated in FIG. 20.

The event determination unit 26 obtains, with a predetermined interval, a log obtained from the structuring support unit 202 by the log obtaining unit 21, and in a case where an occurrence of a particular event is detected, the event determination unit 26 calls the controller unit 24.

The event determination unit 26 refers to, for example, an OS log and a hypervisor log obtained by the log obtaining unit 21, and in a case where information indicating an occurrence of the particular event described above is detected in the log, the event determination unit 26 determines that the event has occurred.

In this case, examples of particular events include acquisition of a snapshot, application of a snapshot, and structuring work. This information processing system 1 carries out snapshot importance level determination upon an occurrence of these particular events.

The particular event is not limited thereto, and the event determination unit 26 may call the controller unit 24 in a case where an event other than the above occurs.

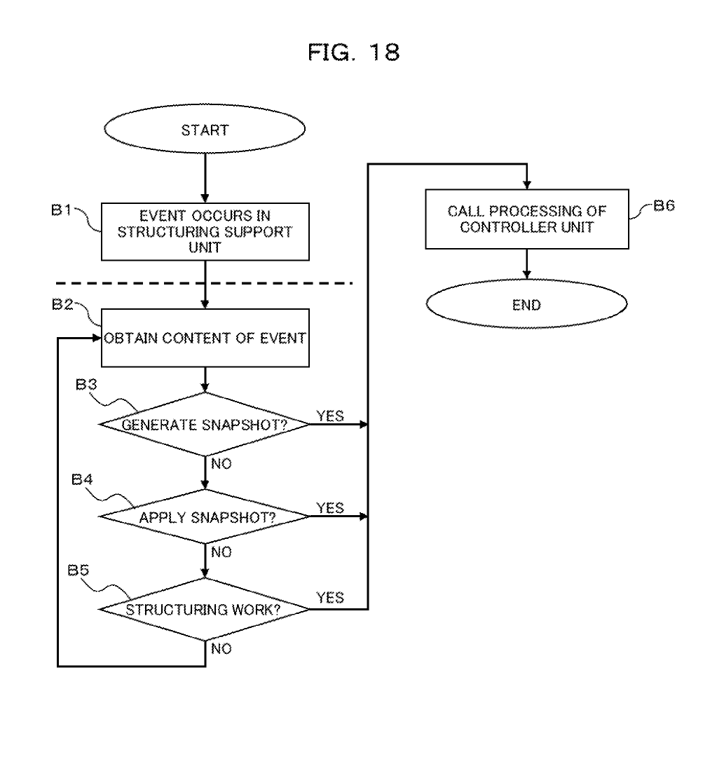

The details of the processing performed with the event determination unit 26 will be explained later with reference to the flowchart as illustrated in FIG. 18.

In a case where the event determination unit 26 determines that a predetermined event occurs, the controller unit 24 calls the log obtaining unit 21, the log analysis unit 22, the snapshot calculation unit 23, the data save processing unit 27, and the snapshot operation unit 25 in accordance with an event of which occurrence has been detected.

The controller unit 24 calls each function in accordance with each event and snapshot deletion policy when a particular event occurs.

For example, the controller unit 24 requests the log obtaining unit 21 to obtain logs of the hypervisor 200 and the virtual machines.

The controller unit 24 requests the data save processing unit 27 to read an importance level point table calculated by the snapshot calculation unit 23.

The controller unit 24 gives the importance level point table and the log information obtained by the log obtaining unit 21 to the log analysis unit 22.

Further, the controller unit 24 gives an analysis result made by the log analysis unit 22 to the snapshot calculation unit 23.

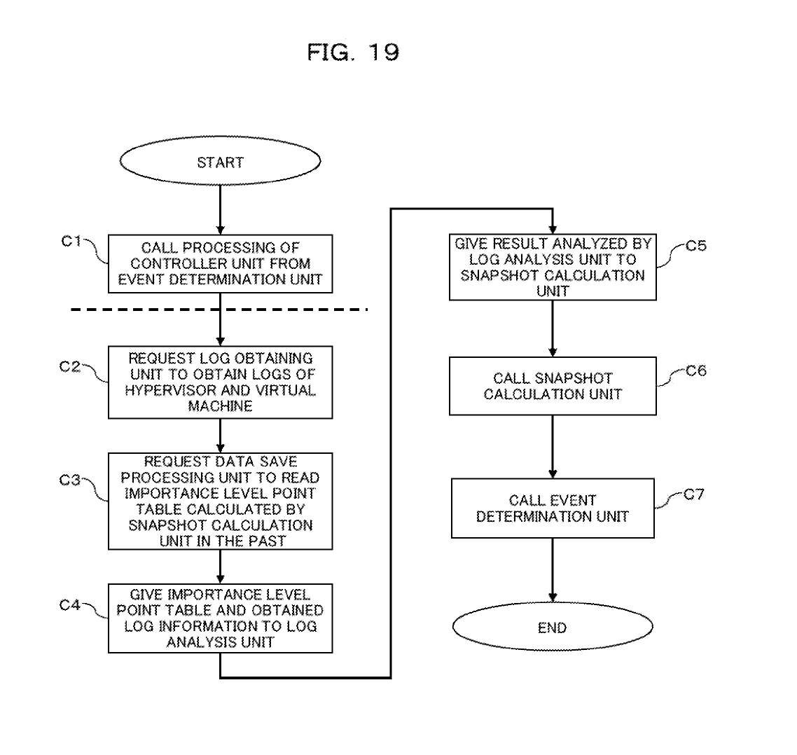

The details of the processing performed with the controller unit 24 will be explained later with reference to the flowchart as illustrated in FIG. 19.

The data save processing unit 27 saves information to the storage unit 30 in accordance with a command given by the controller unit 24.

For example, the data save processing unit 27 stores various kinds of information and flags, which serve as the analysis result made by the log analysis unit 22 explained later, to a predetermined area of the RAM 12 and the HDD 13.

The data save processing unit 27 stores an addition point of an importance level calculated by the snapshot calculation unit 23 and the importance level point information T4 to a predetermined area of the RAM 12 and the HDD 13.

Further, the data save processing unit 27 stores the importance level addition point information T1 to T3 explained later to a predetermined area of the RAM 12 and the HDD 13.

The log analysis unit 22 analyzes the obtained snapshot with regard to the importance level from multiple viewpoints on the basis of various kinds of logs (log information) obtained by the log obtaining unit 21. The log analysis unit 22 analyzes multiple snapshots obtained in one or more virtual machines to prepare various kinds of information and set flags, which the snapshot calculation unit 23 explained later calculates the importance level for each snapshot.

The log analysis unit 22 performs the following four types of analysis (S1) to (S4) on the basis of a relationship property of multiple snapshots formed in a single virtual machine.

The log analysis unit 22 performs the following four types of analysis (P1) to (P4) on the basis of the relationship property of multiple snapshots formed in multiple virtual machines. Hereinafter, a relationship property between snapshots may be referred to as a dependency relationship.

First, the analysis (S1) to (S4) will be explained.

(S1) Analysis of Elapsed Time Between Snapshots

The log analysis unit 22 calculates an elapsed time between snapshots in the virtual machine. More specifically, the log analysis unit 22 calculates, in any given virtual machine, a time elapsed from when a snapshot was formed first to when a snapshot was formed subsequently.

In this information processing system 1, a snapshot is obtained before and after structuring is performed with the structuring support unit 202. Therefore, the elapsed time between snapshots represents a time required for the structuring work.

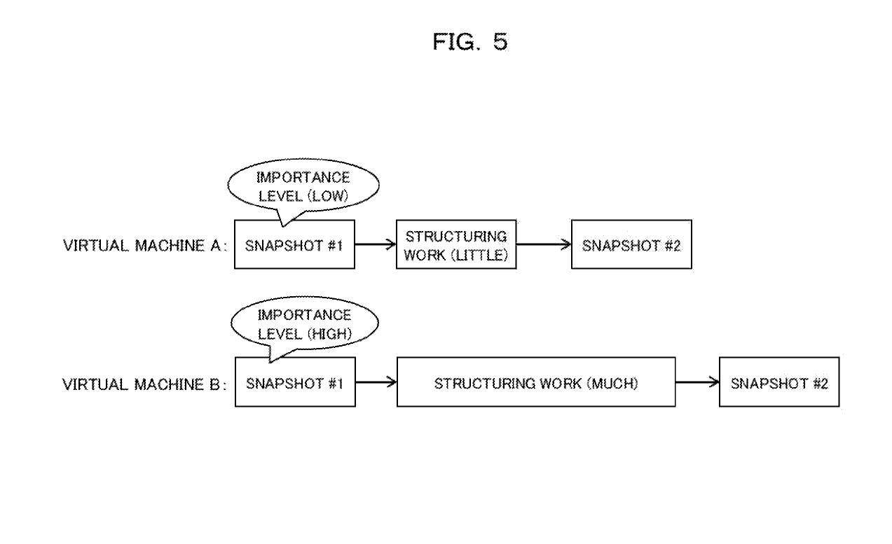

FIG. 5 is a figure illustrating an example of an elapsed time between snapshots.

In the example as illustrated in FIG. 5, in each of the virtual machines A, B, a snapshot #1 is obtained before a structuring work, and a snapshot #2 is obtained after the structuring work.

In this information processing system 1, when the time required for the structuring work is longer, the importance level of the snapshot obtained immediately before the structuring work is treated as being higher.

In the example as illustrated in FIG. 5, the amount of work of the structuring work of the virtual machine B is more than the amount of work of the structuring work of the virtual machine A, and therefore, the structuring work time in the virtual machine B is longer than the structuring work of the virtual machine A.

In such case, the snapshot #1 of the virtual machine B is treated as having a higher importance level than the snapshot #1 of the virtual machine A by the snapshot calculation unit 23 explained later.

The log analysis unit 22 causes the data save processing unit 27 to store the calculated elapsed time between snapshots into a predetermined area of the storage unit 30. For example, the log analysis unit 22 stores an elapsed time required to obtain a subsequent snapshot to a predetermined area of the storage unit 30, in such a manner that the elapsed time is associated with each snapshot.

(S2) Analysis of Operation Content During Acquisition of Snapshot

In a case where structuring works of the same category continue multiple times for a single virtual machine, the log analysis unit 22 counts the number of times multiple snapshots are obtained with regard to the structuring works of the same category.

The snapshot calculation unit 23 explained later sets an importance level for a snapshot obtained immediately before the first structuring work in accordance with the number of times the structuring works of the same category are performed continuously.

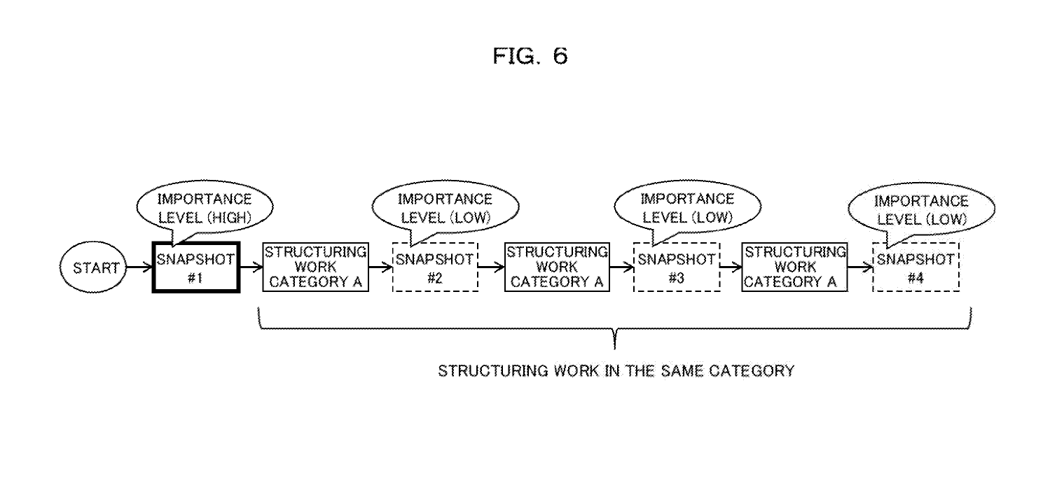

FIG. 6 is a figure for explaining a relationship between a structuring work and a snapshot.

In this information processing system 1, in a case where the structuring works of the same category are performed multiple times on the same device, a snapshot obtained immediately before the first structuring work of multiple structuring works of the same category is treated as having a higher importance level than the other snapshots.

The log analysis unit 22 counts the number of snapshots obtained in accordance with the structuring works of the same category, i.e., the number of obtained snapshots.

Then, the log analysis unit 22 stores the number of snapshots obtained in accordance with the structuring works of the same category, which has been counted, into a predetermined area of the storage unit 30 via the data save processing unit 27. For example, the log analysis unit 22 stores the number of snapshots obtained in accordance with the structuring works of the same category in such a manner that it is associated with the snapshot obtained immediately before the first structuring work of multiple structuring works of the same category.

(S3) Analysis of Child Tree Number Sequence

In a tree structure of snapshots, the log analysis unit 22 counts the number of snapshots connected at a lower position with respect to each snapshot.

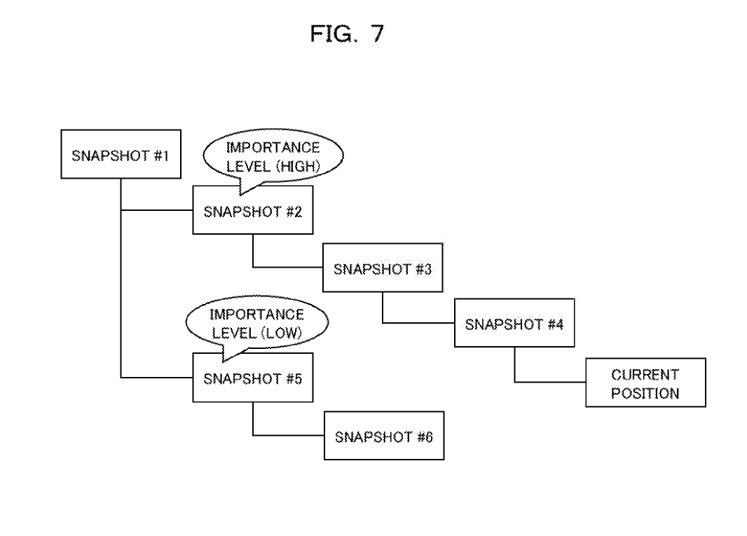

FIG. 7 is a figure illustrating an example of a tree structure of snapshots. In the operation server 10b, multiple snapshots are obtained (six snapshots are obtained in the example as illustrated in FIG. 7), and these multiple snapshots form a tree-shaped hierarchical structure. Hereinafter, a hierarchical structure of snapshots represented on a tree will be referred to as a snapshot tree.

For example, in the snapshot tree as illustrated in FIG. 7, a snapshot #2 and a snapshot #5 are formed in parallel at the lower position with respect to a snapshot #1. A snapshot #3 is formed at the lower position with respect to the snapshot #2, and a snapshot #4 is formed at the lower position with respect to the snapshot #3. Accordingly, in the snapshot #1, the snapshots #2 to #4 are sequentially formed. A snapshot #6 is formed at the lower position with respect to the snapshot #5.

In the tree structure, a portion at a lower position will be hereinafter referred to as a child tree, and a number of snapshots included in the child tree will be referred to as a child tree number. For example, the child tree of the snapshot #1 includes the snapshots #2, #3, #4 and the snapshots #5, #6. More specifically, the child tree number of the snapshot #1 is five.

In this information processing system 1, the higher the child tree number is, the higher the importance level of the snapshot is treated as.

The log analysis unit 22 stores the child tree number, derived for each snapshot, to a predetermined area of the storage unit 30 via the data save processing unit 27.

At this occasion, for a snapshot having the highest child tree number, the log analysis unit 22 sets a flag indicating that the child tree number sequence is the first. For a snapshot having the second highest child tree number, the log analysis unit 22 sets a flag indicating that the child tree number sequence is the second. These flags are stored to a predetermined area of the storage unit 30 by the data save processing unit 27.

(S4) Analysis of Branch Tree Number

The log analysis unit 22 counts a branch number in a snapshot tree (branch tree number).

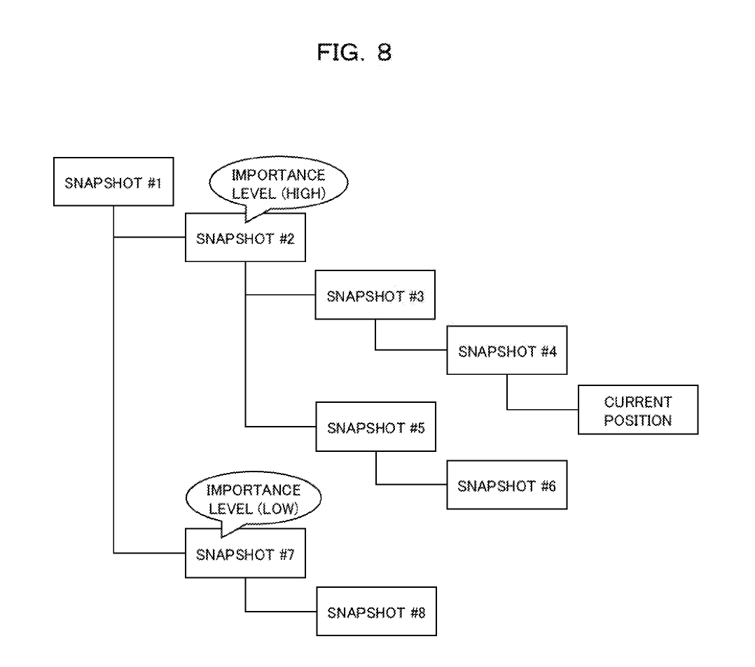

FIG. 8 is a figure illustrating an example of a tree structure of snapshots. In the snapshot tree as illustrated in FIG. 8, for example, a snapshot #2 and a snapshot #7 are formed in parallel at a lower position with respect to a snapshot #1.

A snapshot #3 and a snapshot #5 are formed in parallel at a lower position with respect to the snapshot #2. The snapshot #3 is formed at a lower position with respect to the snapshot #2, and a snapshot #4 is formed at a lower position with respect to the snapshot #3.

A snapshot #6 is formed at a lower position with respect to the snapshot #5, and a snapshot #8 is formed at a lower position with respect to the snapshot #7.

As described above, at the snapshot #2, the snapshot tree is branched into the snapshot #3 and the snapshot #5 (branch tree number=2), and the snapshot #2 is a branch point.

In this information processing system 1, an importance level of a snapshot at a branch point is treated as being high.

The log analysis unit 22 stores a branch tree number, derived for each snapshot, to a predetermined area of the storage unit 30.

Subsequently, analysis (P1) to (P4) will be explained.

As explained above, the analysis (P1) to (P4) are performed on the basis of a relationship property of multiple snapshots formed in multiple virtual machines. A relationship property of multiple snapshots formed in multiple virtual machines can also be said to be a dependency relationship. When there is a relationship between snapshots obtained each of multiple virtual machines, this will be referred to as having a dependency relationship.

The log analysis unit 22 determines whether there is a dependency relationship between snapshots obtained in each of multiple virtual machines.

In this information processing system 1, a snapshot having a dependency relationship will be treated as having a high importance level.

(P1) Analysis as to Whether Acquisition of Snapshots is Repeated in Multiple Virtual Machines

In a case where a snapshot is obtained in any given virtual machine of multiple virtual machines, and thereafter, a snapshot is formed in other virtual machines within a predetermined period of time multiple times repeatedly, the log analysis unit 22 determines that there is a dependency relationship between snapshots obtained in these virtual machines.

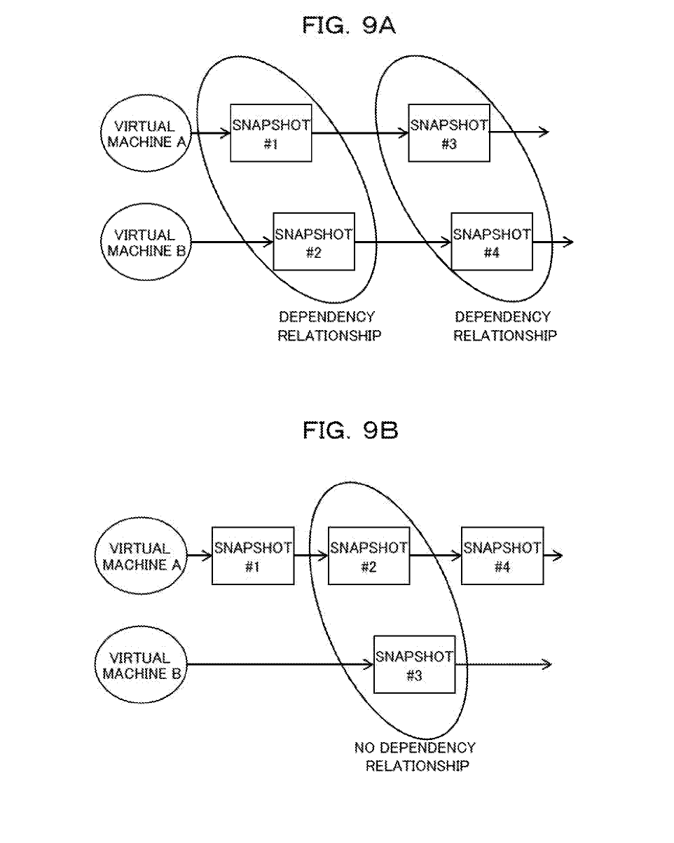

FIGS. 9A and 9B are figures for explaining a determination method for determining whether there is a dependency relationship or not on the basis of a repetition of acquisition of snapshots in multiple virtual machines.

In FIGS. 9A and 9B, FIG. 9A illustrates an example where there is a dependency relationship between snapshots obtained in each of two virtual machines A, B. FIG. 9B illustrates an example where there is not any dependency relationship between snapshots obtained in each of two virtual machines A, B.

In FIG. 9A, the snapshot #2 is formed in the virtual machine B within a predetermined period of time after the snapshot #1 is obtained in the virtual machine A. In the virtual machine A, the snapshot #3 is obtained after the snapshot #1, and the snapshot #4 is obtained in the virtual machine B within a predetermined period of time since the snapshot #3 is obtained.

More specifically, a combination in which the snapshot (#2 or #4) is obtained in the virtual machine B after the snapshot (#1 or #3) is obtained in the virtual machine A is determined to have a dependency relationship with the snapshot #2 obtained in the virtual machine B. Likewise, the log analysis unit 22 determines there is a dependency relationship between the snapshot #3 obtained in the virtual machine A and the snapshot #4 obtained in the virtual machine B.

In FIG. 9B, after the snapshot #2 is obtained in the virtual machine A, the snapshot #3 is formed in the virtual machine B within a predetermined period of time. However, a combination in which a snapshot is obtained in the virtual machine B after a snapshot is obtained in the virtual machine A is not repeatedly performed.

Therefore, in FIG. 9B, the log analysis unit 22 determines there is not any dependency relationship between the snapshot #2 obtained in the virtual machine A and the snapshot #3 obtained in the virtual machine B.

In a case where a combination of acquisition of snapshots is repeatedly detected in multiple virtual machines, the log analysis unit 22 stores, with regard to each snapshot constituting the combination, a flag indicating that effect to a predetermined area of the storage unit 30 via the data save processing unit 27.

(P2) Analysis as to Whether Reboot Occurs Simultaneously in Multiple Virtual Machines

In a case where reboot is performed with the same timing (simultaneously) in multiple virtual machines, the log analysis unit 22 determines that there is a dependency relationship between snapshots obtained in each virtual machine of multiple virtual machines before reboot.

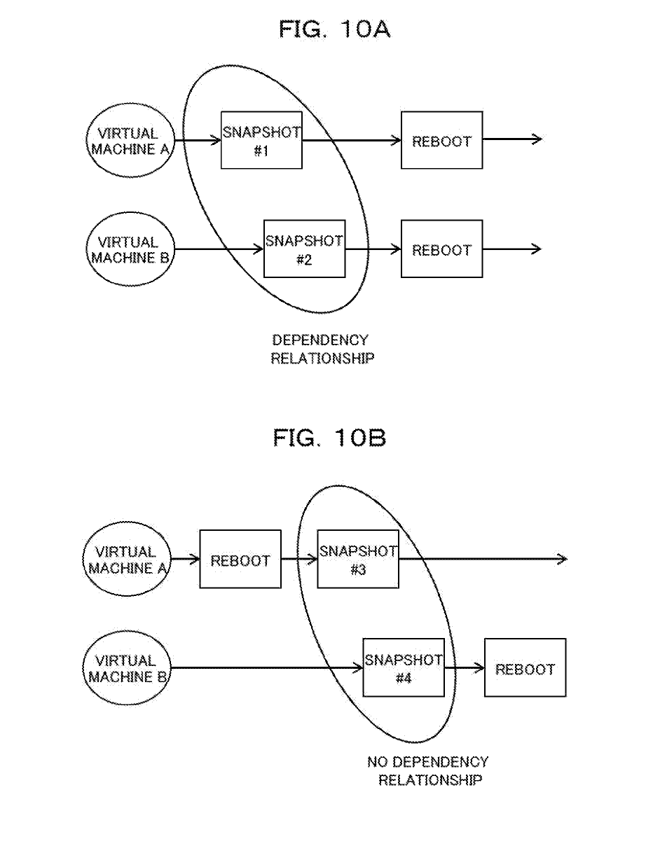

FIGS. 10A and 10B are figures for explaining a determination method for determining whether there is a dependency relationship or not on the basis of reboot performed simultaneously in multiple virtual machines.

In FIGS. 10A and 10B, FIG. 10A illustrates an example where there is a dependency relationship between snapshots obtained in each of two virtual machines A, B. FIG. 10B illustrates an example where there is not any dependency relationship between snapshots obtained in each of two virtual machines A, B.

In FIG. 10A, after the snapshot #1 is obtained in the virtual machine A, this virtual machine A is rebooted within a predetermined period of time. After the snapshot #2 is obtained in the virtual machine B, this virtual machine B is rebooted within a predetermined period of time. The virtual machines A, B are rebooted with the same timing.

“The virtual machines A, B are rebooted simultaneously, or rebooted with the same timing” means that a difference between a point in time at which the virtual machine A is rebooted and a point in time at which the virtual machine B is rebooted is within a predetermined period of time (for example, within three minutes).

In the virtual machines A, B, the snapshots #1, #2 are preferably generated within a predetermined time range (for example, within 2 hours) from a point in time at which the virtual machines A, B are rebooted.

In FIG. 10B, the virtual machines A, B are rebooted, but these reboots are not performed with the same timing. In the virtual machine A, rebooting is performed before the snapshot #3 is obtained, and in the virtual machine B, rebooting is performed after the snapshot #4 is obtained.

As described above, in the example as illustrated in FIG. 10B, the timing of rebooting does not match between the virtual machines A, B, and therefore, these snapshots #3, #4 do not have any dependency relationship based on simultaneous rebooting.

In a case where the virtual machines A, B are simultaneously rebooted, the log analysis unit 22 determines that there is a dependency relationship between the snapshot #1 obtained in the virtual machine A and the snapshot #2 obtained in the virtual machine B before the rebooting is performed.

In a case where multiple virtual machines are determined to have been simultaneously rebooted, the log analysis unit 22 stores, with regard to the snapshot obtained in each virtual machine before the rebooting, a flag indicating an execution of simultaneous rebooting into a predetermined area of the storage unit 30 via the data save processing unit 27.

(P3) Analysis as to Whether IP Addresses of Each Other are Output in Event Logs of Multiple Virtual Machines

In a case where IP addresses of each other are included in event logs each of which is output during acquisition of a snapshot in multiple virtual machines in each of which a snapshot is obtained within a predetermined period of time, the log analysis unit 22 determines that there is a dependency relationship between snapshots obtained in each virtual machine.

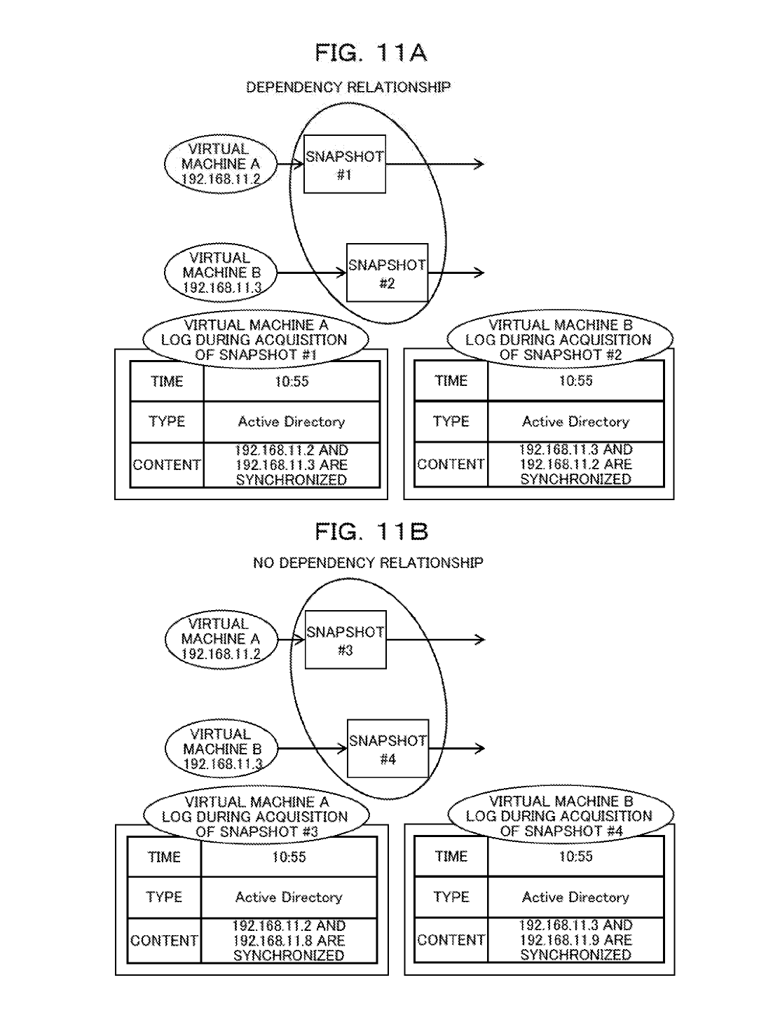

FIGS. 11A and 11B are figures for explaining a determination method for determining whether there is a dependency relationship or not on the basis of an IP address of an event log in multiple virtual machines.

FIG. 11A illustrates an example where there is a dependency relationship between snapshots obtained in the two virtual machines A, B. FIG. 11B illustrates an example where there is not any dependency relationship between snapshots obtained in the two virtual machines A, B.

In the example as illustrated in FIG. 11, the IP address of the virtual machine A is “192.168.11.2”, and the IP address of the virtual machine B is “192.168.11.3”.

In FIG. 11A, after the snapshot #1 is obtained in the virtual machine A, the snapshot #2 is obtained in the virtual machine B within a predetermined period of time. The IP address of the virtual machine B “192.168.11.3” is in an event log obtained in the virtual machine A by the log obtaining unit 21 when the snapshot #1 is obtained (see content field). Likewise, the IP address of the virtual machine A “192.168.11.2” is in an event log obtained in the virtual machine B by the log obtaining unit 21 when the snapshot #2 is obtained (see content field).

In such case, the log analysis unit 22 determines there is a dependency relationship between the snapshot #1 obtained in the virtual machine A and the snapshot #2 obtained in the virtual machine B.

In FIG. 11B, the snapshots #3, #4 are obtained in the virtual machines A, B within a predetermined period of time, but the IP addresses of the virtual machine B, A of each other are not included in event logs each of which is obtained during acquisition of the snapshots #3, #4. Therefore, there is not any dependency relationship between the snapshots #3, #4 on the basis of the IP addresses of each other.

In a case where the IP addresses of the virtual machines of each other are included in event logs each of which is output during acquisition of a snapshot in multiple virtual machines in each of which a snapshot is obtained within a predetermined period of time, the log analysis unit 22 stores, with regard to a snapshot obtained in each virtual machine at that point in time, a flag indicating that the IP addresses of the virtual machines of each other are included in event logs to a predetermined area of the storage unit 30 via the data save processing unit 27.

(P4) Analysis as to Whether the Same Category Contents are Output in OS Event Logs of Multiple Virtual Machines

In a case where the same category contents are output in event logs each of which is output during acquisition of a snapshot in multiple virtual machines in each of which a snapshot is obtained within a predetermined period of time, the log analysis unit 22 determines that there is a dependency relationship between snapshots obtained in each virtual machine.

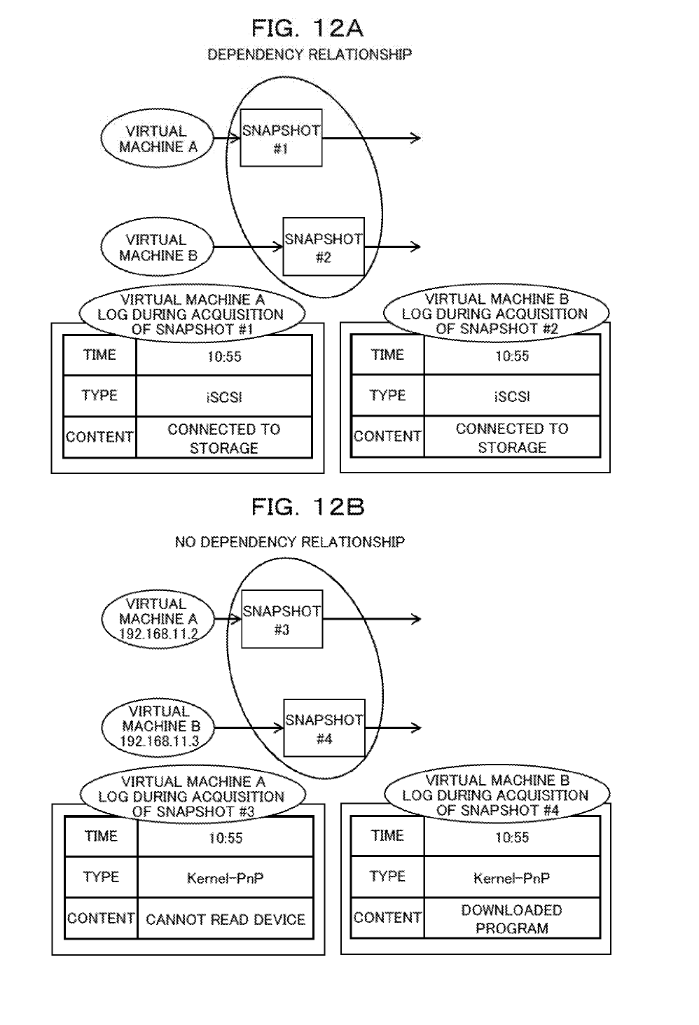

FIGS. 12A and 12B are figures for explaining a determination method for determining whether there is a dependency relationship or not on the basis of category contents in event logs in multiple virtual machines.

FIG. 12A illustrates an example where there is a dependency relationship between snapshots obtained in the two virtual machines A, B. FIG. 12B illustrates an example where there is not any dependency relationship between snapshots obtained in the two virtual machines A, B.

In FIG. 12A, after the snapshot #1 is obtained in the virtual machine A, the snapshot #2 is obtained in the virtual machine B within a predetermined period of time. The content of an event log obtained in the virtual machine A by the log obtaining unit 21 during acquisition of the snapshot #1 includes a description “connected to storage” (see content field). Likewise, the content of the event log obtained in the virtual machine B by the log obtaining unit 21 during acquisition of the snapshot #2 also includes a description “connected to storage” (see content field).

The category content represents processing executed on the OS, and corresponds to, for example, a category of a task in a log (Windows log) of Windows (registered trademark).

As described above, in a case where the same category contents are included in OS event logs obtained during acquisition of snapshots in multiple virtual machines, the log analysis unit 22 determines that there is a dependency relationship between the snapshot #1 obtained in the virtual machine A and the snapshot #2 obtained in the virtual machine B.

In FIG. 12B, the snapshots #3, #4 are obtained in the virtual machines A, B within a predetermined period of time, but the content of an event log at the point in time when the snapshot #3 is obtained in the virtual machine A includes a description “cannot read device” (see content field). On the other hand, the content of an event log at the point in time when the snapshot #4 is obtained in the virtual machine B includes a description “could not download program” (see content field). As described above, in a case where the same category contents are not included in OS event logs during acquisition of snapshots in multiple virtual machines, there is not any dependency relationship between the snapshots #3, #4 on the basis of the IP addresses of each other.

In a case where the same category contents are included in each event log that is output during acquisition of a snapshot in multiple virtual machines in each of which a snapshot is obtained within a predetermined period of time, the log analysis unit 22 stores, with regard to a snapshot obtained in each virtual machine at that point in time, a flag indicating that the same category contents are output in event logs to a predetermined area of the storage unit 30 via the data save processing unit 27.

The snapshot calculation unit 23 determines an importance level for each snapshot on the basis of results of the analysis (S1) to (S4), (P1) to (P4) performed by the log analysis unit 22. More specifically, the snapshot calculation unit 23 digitalizes the importance level of each snapshot on the basis of a relationship property (relationship state, dependency relationship) between snapshots analyzed by the log analysis unit 22. More specifically, the importance level point (importance level information) of each snapshot is calculated.

In a case where it is determined that there is a dependency relationship between multiple snapshots formed in multiple virtual machines in the above analysis (P1) to (P4), the log analysis unit 22 stores a flag indicating that there is a combination of dependency relationships to a predetermined area of the storage unit 30 via the data save processing unit 27.

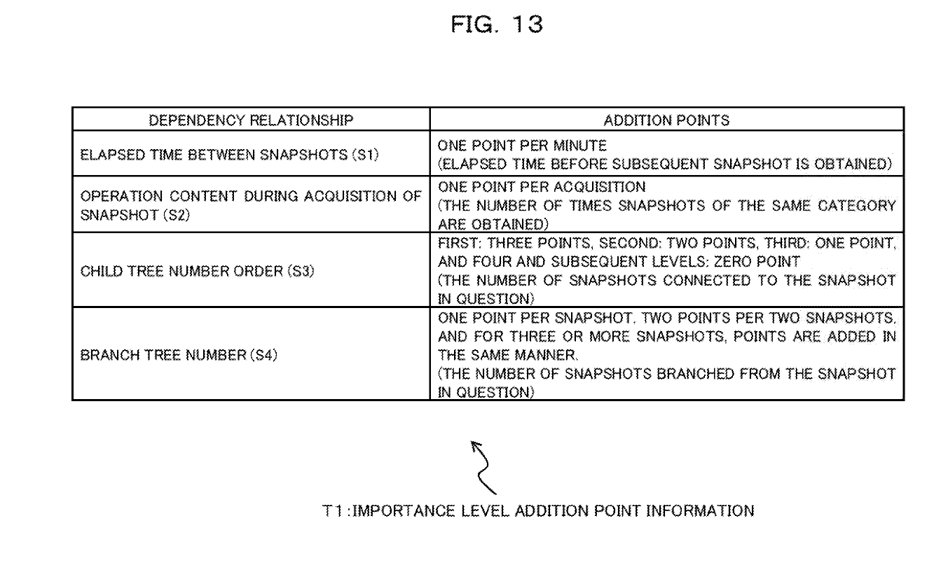

FIG. 13 is a figure illustrating an example of importance level addition point information T1 used by the snapshot calculation unit 23 of the information processing system 1 serving as an example of an embodiment.

The importance level addition point information T1 as illustrated in FIG. 13 indicates indexes of addition points for digitalizing results of the analysis (S1) to (S4) produced by the log analysis unit 22 explained above. More specifically, with regard to each of the analysis (S1) to (S4) indicating the dependency relationship, a method for digitalizing a result thereof is illustrated in association as an addition point.

The importance level addition point information T1, for example, illustrated in FIG. 13, illustrates the dependency relationships and the addition points in a table. This importance level addition point information T1 may be expressed as an importance level addition point table T1.

The snapshot calculation unit 23 refers to the importance level addition point information T1, and adds a point defined as an addition point to a snapshot corresponding to conditions (S1) to (S4) indicating dependency relationships.

In the example as illustrated in FIG. 13, “one point per minute” is associated as an addition point with the condition (S1) indicating an elapsed time between snapshots. Therefore, when an elapsed time from when a previous snapshot is obtained to when a subsequent snapshot is obtained is longer, an addition point for the previous snapshot is higher.

“One point per acquisition” is associated with a condition (S2) indicating an operation content during acquisition of a snapshot. Therefore, in a case where the structuring works of the same category are performed continuously multiple times, point addition is performed for the snapshot obtained immediately before the first structuring work in multiple structuring works of the same category in accordance with the number of times the structuring works of the same category are repeated.

“First: three points, second: two points, third: one point, and four and subsequent levels: zero point” are associated with the condition (S3) indicating the child tree number sequence. Accordingly, a higher addition point is given to a snapshot having a larger child tree number.

“One point per snapshot, two points per two snapshots, and for three or more snapshots, points are added in the same manner” are associated with the condition (S4) indicating the branch tree number. This indicates that a point as many as the value of tree number (branch number, branch tree number), which is the number of trees branching from a snapshot making a branch point, is added to the snapshot. Therefore, a higher addition point is given to a snapshot having a larger branch tree number.

The addition point that is set with the importance level addition point information T1 is not limited to those illustrated in FIG. 13. This can be carried out upon appropriately applying changes.

A specific example of a method for calculating an importance level of a specific snapshot using this importance level addition point information T1 will be explained later.

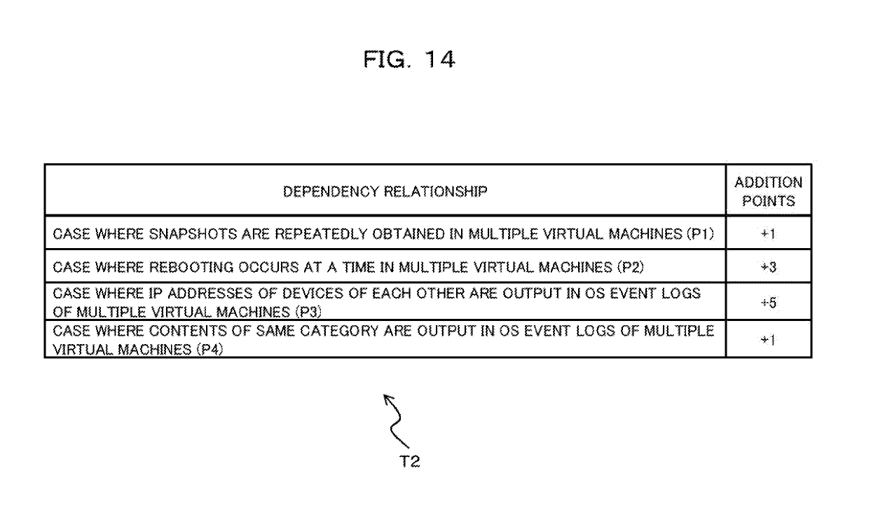

FIG. 14 is a figure illustrating an example of importance level addition point information T2 used by a snapshot calculation unit 23 of the information processing system 1 serving as an example of an embodiment.

The importance level addition point information T2 as illustrated in FIG. 14 indicates addition points for digitalizing results of the analysis (P1) to (P4) made by the log analysis unit 22 explained above. More specifically, with regard to each of the analysis (P1) to (P4) indicating the dependency relationship, a method for digitalizing a result thereof is illustrated in association as an addition point.

The importance level addition point information T2, for example, illustrated in FIG. 14, also illustrates the dependency relationships and the addition points in a table. This importance level addition point information T2 may be expressed as an importance level addition point table T2.

The snapshot calculation unit 23 refers to the importance level addition point table T2, and adds a point defined as an addition point to a snapshot corresponding to conditions (P1) to (P4) indicating dependency relationships.

In the example as illustrated in FIG. 14, “+1” is associated as an addition point with the condition (P1) indicating that acquisition of snapshots is repeated in multiple virtual machines.

“+3” is associated as an addition point with the condition (P2) indicating that reboot occurs simultaneously in multiple virtual machines.

“+5” is associated as an addition point with the condition (P3) indicating that IP addresses of each other are output in OS event logs in multiple virtual machines.

Further, “+1” is associated as an addition point with the condition (P4) indicating that the same category contents are output in OS event logs of multiple virtual machines.

The addition points that are set with the importance level addition point information T2 are not limited to those illustrated in FIG. 14. This can be carried out upon appropriately applying changes.

A specific example of a method for calculating an importance level of a specific snapshot using this importance level addition point table T2 will be explained later.

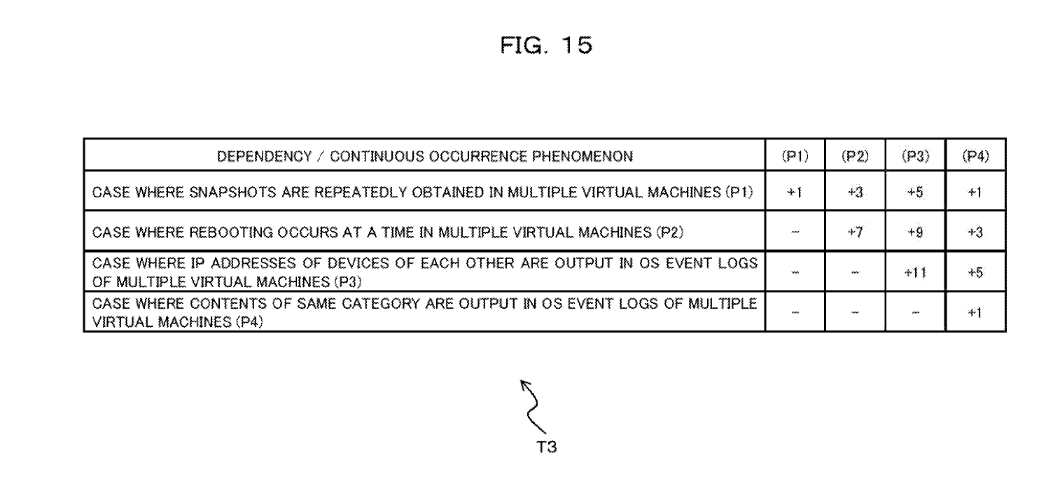

FIG. 15 is a figure illustrating an example of importance level addition point information T3 used by a snapshot calculation unit 23 of the information processing system 1 serving as an example of an embodiment.

In a case where multiple dependency relationships between snapshots obtained in multiple virtual machines are continuously detected by the log analysis unit 22, the snapshot calculation unit 23 adds an importance level by using the importance level addition point information T3 as illustrated in FIG. 15 as an example.

More specifically, the snapshot calculation unit 23 performs calculation of the importance level with the importance level addition point information T1, T2 explained above but also addition of an importance level based on the importance level addition point information T3.

In the importance level addition point information T3 as illustrated in FIG. 15, addition points are set for combinations of the analysis (P1) to (P4) explained above.

The addition points that are set with the importance level addition point information T3 are not limited to those illustrated in FIG. 15. This can be carried out upon appropriately applying changes.

For each snapshot, the snapshot calculation unit 23 adds addition points from the importance level addition point information T1 to T3 explained above to calculate the importance level point.

The importance level addition point information T1 to T3 serves as criteria for setting the importance level point for each snapshot, and functions as a point policy.

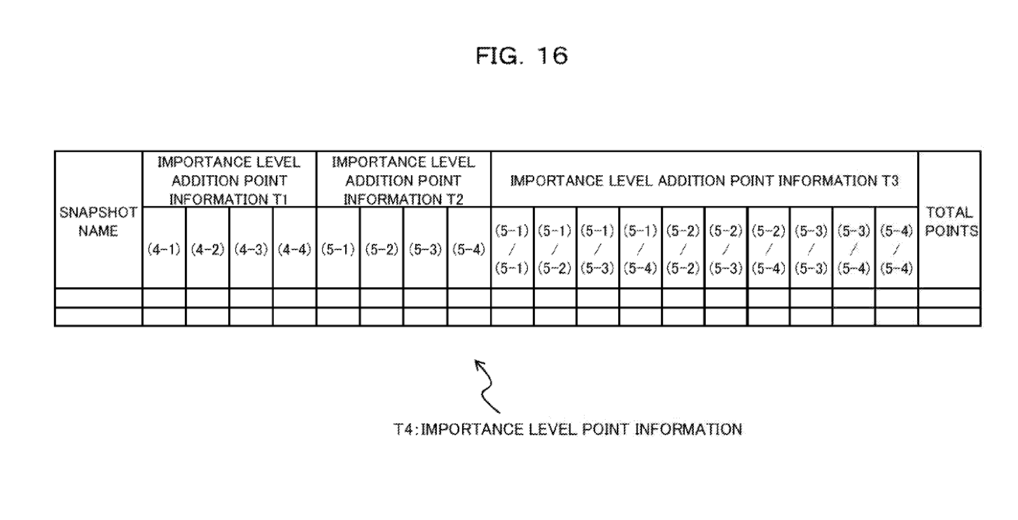

FIG. 16 is a figure illustrating an example of importance level point information T4 used by the snapshot calculation unit 23 of the information processing system 1 serving as an example of an embodiment.

The importance level point information T4 as illustrated in FIG. 16 is constituted as a table including a combination of addition points derived by using the importance level addition point information T1 to T3 explained above with regard to a snapshot identified by a snapshot name.

With the importance level point information T4, the snapshot calculation unit 23 registers an addition point in a portion corresponding to analysis in which a dependency relationship is detected by the log analysis unit 22 explained above.

Then, for each snapshot, the addition points registered in the importance level point information T4 are added for each snapshot, so that the summation point is calculated as the importance level of the snapshot.

This importance level point information T4 is stored to a predetermined area of the storage unit 30 by the data save processing unit 27.

The snapshot operation unit 25 deletes a snapshot.

For example, in a case where the controller unit 24 detects a phenomenon matching a snapshot deletion policy, the snapshot operation unit 25 is called by the controller unit 24 to perform deletion processing of a snapshot.

The snapshot deletion policy is defined in advance as, for example, a snapshot upper limit number of a virtual machine in the management server 10a and a lower limit value of IO (Input Output) performance of the operation server 10b and the like.

Then, in a case where the controller unit 24 detects the snapshot upper limit number of the virtual machine is attained in the management server 10a or in a case where the controller unit 24 detects that the IO (Input Output) performance of the operation server 10b and the like decreases to a level lower than a predetermined threshold value, the controller unit 24 gives a deletion command of the snapshot to the snapshot operation unit 25.

The IO performance of the operation server 10b and the like is expressed as, for example, IO/sec.

The snapshot operation unit 25 preferentially deletes a snapshot having a smaller value of an importance level (summation point of importance level additions) calculated by the snapshot calculation unit 23 explained above. In a case where the values of the importance levels are the same, an older snapshot is preferentially deleted.

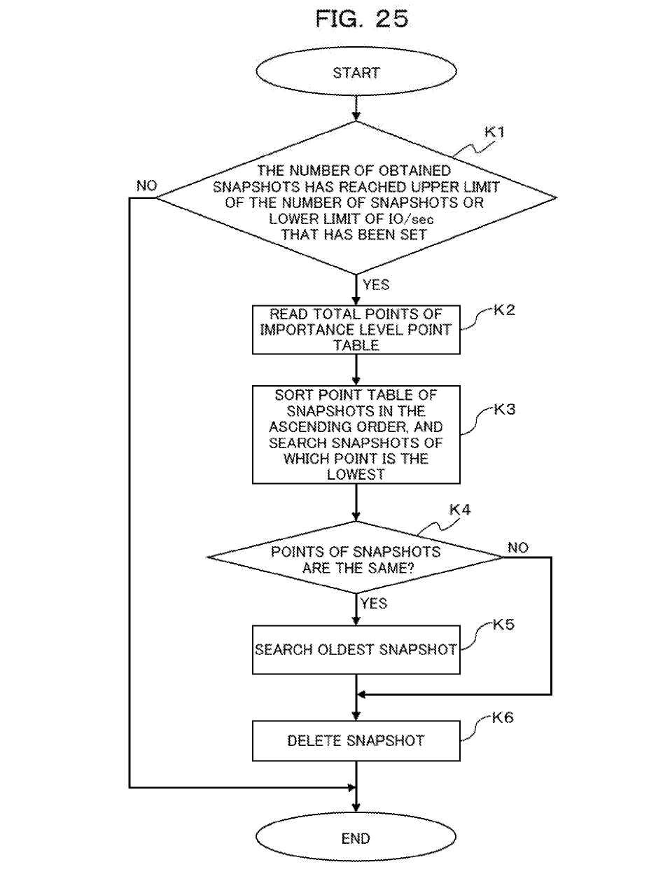

The details of the processing performed with the snapshot operation unit 25 will be explained with reference to a flowchart as illustrated in FIG. 25.

### (B) Operation

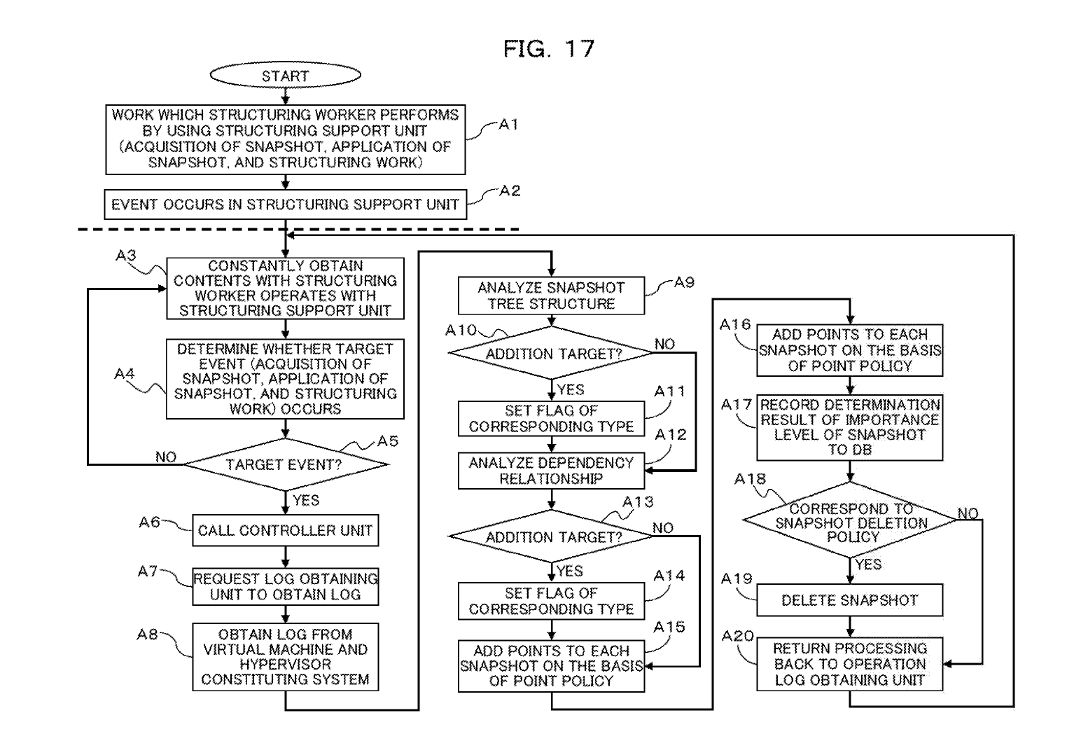

First, an overview of processing performed with the snapshot importance level determination unit 201 in the information processing system 1 serving as an example of an embodiment configured as described above will be explained with reference to the flowchart (steps A1 to A20) as illustrated in FIG. 17.

In step A1, a worker (structuring worker) performs any one of acquisition of a snapshot, application of a snapshot, or structuring work with the structuring support unit 202 on the management server 10a. Accordingly, an event occurs in the structuring support unit 202 (step A2).

In step A3, the event determination unit 26 obtains a content, which the worker is operating from the structuring support unit 202 by using the structuring support GUI 2022.

In step A4, the event determination unit 26 determines whether a particular event, i.e., a trigger for an importance level determination of a snapshot, occurs or not. The predetermined event is acquisition of a snapshot, application of a snapshot, or structuring work.

As a result of the determination (step A5), in a case where there does not occur any particular event of a target (see NO route in step A5), step A3 is performed back again. In a case where there occurs a particular event (see YES route in step A5), the event determination unit 26 calls the controller unit 24 in step A6.

In step A7, the controller unit 24 requests the log obtaining unit 21 to obtain logs. In step A8, the log obtaining unit 21 obtains logs from each virtual machine and the hypervisor 200 constituting the system of the operation server 10b.

In step A9, the log analysis unit 22 analyzes the snapshot tree structure, and performs analysis (S1) to (S4) on the basis of a relationship property of multiple snapshots formed in a single virtual machine on the basis of this snapshot tree. In step A10, as a result of the analysis (S1) to (S4), the log analysis unit 22 confirms whether there is any result corresponding to an addition target of an importance level point. In a case where there is not any result corresponding to the addition target of the importance level point as a result of the analysis (S1) to (S4) (see NO route in step A10), step A12 is subsequently performed.

In a case where there is a result corresponding to the addition target of the importance level point as a result of the analysis (S1) to (S4) (see YES route in step A10), the log analysis unit 22 stores, with regard to the corresponding condition, a count result and a flag to the storage unit 30 in step A11.

In step A12, the log analysis unit 22 analyzes a relationship property of multiple snapshots (dependency relationship) formed in multiple virtual machines, and performs the analysis (P1) to (P4) on the basis of the relationship property.

In step A13, the log analysis unit 22 checks whether there is any result corresponding to an addition target of an importance level point as a result of the analysis (P1) to (P4). In a case where there is not any result corresponding to the addition target of the importance level point as a result of the analysis (P1) to (P4) (see NO route in step A13), step A15 is subsequently performed.

In a case where there is a result corresponding to the addition target of the importance level point as a result of the analysis (P1) to (P4) (see YES route in step A13), the log analysis unit 22 stores, with regard to the corresponding condition, a flag to the storage unit 30 in step A14.

In step A15, the snapshot calculation unit 23 sets an importance level addition point for each snapshot on the basis of a point policy (importance level addition point information T1) on the basis of a relationship property of multiple snapshots formed in a single virtual machine.

In step A16, the snapshot calculation unit 23 sets an importance level addition point for each snapshot on the basis of a point policy (importance level addition point information T2, T3) on the basis of a relationship property of multiple snapshots formed in multiple virtual machines.

The snapshot calculation unit 23 registers an importance level addition point, which is set for each snapshot, with the importance level point information T4.

In step A17, the data save processing unit 27 registers the importance level point information T4 to the snapshot importance level determination DB 34.

In step A18, the snapshot operation unit 25 determines whether the snapshot corresponds to a snapshot deletion policy or not. In a case where the snapshot corresponds to the snapshot deletion policy (see YES route in step A18), the snapshot operation unit 25 deletes the snapshot in step A19.

Thereafter, in step A20, the snapshot operation unit 25 returns the processing back to the log obtaining unit 21. More specifically, step A3 is subsequently performed.

In a case where the snapshot does not correspond to the snapshot deletion policy as a result of the determination in step A18 (see NO route in step A18), step A20 is subsequently performed.

Subsequently, processing of the event determination unit 26 in the information processing system 1 serving as an example of an embodiment will be explained with reference to the flowchart (steps B1 to B6) as illustrated in FIG. 18.

When a worker performs any one of acquisition of a snapshot, application of a snapshot, or structuring work with the structuring support unit 202 on the management server 10a, an event occurs in the structuring support unit 202 (step B1).

In step B2, the event determination unit 26 obtains a content of an event that has occurred. In step B3, the event determination unit 26 determines whether the event that has occurred is a snapshot generation or not. In a case where the event that has occurred is the snapshot generation (see YES route in step B3), step B6 is subsequently performed.

In a case where an event that has occurred is not the snapshot generation (see NO route in step B3), step B4 is subsequently performed.

In step B4, the event determination unit 26 determines whether the event that has occurred is application of a snapshot or not. In a case where the event that has occurred is application of a snapshot (see YES route in step B4), step B6 is subsequently performed.

In a case where the event that has occurred is not is not application of a snapshot (see NO route in step B4), step B5 is subsequently performed.

In step B5, the event determination unit 26 determines whether the event that has occurred is a structuring work or not. In a case where the event that has occurred is the structuring work (see YES route in step B5), step B6 is subsequently performed.

In a case where an event that has occurred is not the structuring work (see NO route in step B5), step B2 is subsequently performed.

In step B6, the event determination unit 26 performs call processing of the controller unit 24, and terminates the processing.

Subsequently, processing of the controller unit 24 of the information processing system 1 serving as an example of an embodiment will be explained with reference to the flowchart (steps C1 to C7) as illustrated in FIG. 19.

When the call processing of the controller unit 24 is performed from the event determination unit 26 in step C1, the controller unit 24 requests the log obtaining unit 21 to obtain logs of the hypervisor 200 and each virtual machine in step C2.

In step C3, the log obtaining unit 21 requests the data save processing unit 27 to read the importance level point information T4 calculated by the snapshot calculation unit 23 in the past.

In step C4, the controller unit 24 gives the importance level point information T4 read by the data save processing unit 27 and the obtained log information to the log analysis unit 22.

In step C5, the controller unit 24 gives a result analyzed by the log analysis unit 22 to the snapshot calculation unit 23.

In step C6, the controller unit 24 calls the snapshot calculation unit 23, and in step C7, the controller unit 24 calls the event determination unit 26, and terminates the processing.

Subsequently, processing of the log obtaining unit 21 of the information processing system 1 serving as an example of an embodiment will be explained in accordance with the flowchart (steps D1 to D6) as illustrated in FIG. 20.

When the controller unit 24 requests the log obtaining unit 21 to obtain logs of each device (the hypervisor 200, each virtual machine, and the like) in step D1, the log obtaining unit 21 requests the structuring support unit 202 to obtain logs of each device in step D2.

In step D3, a loop processing for repeatedly carrying out control from step D3 to step D5 is started on all the devices (the hypervisor 200 and each virtual machine) existing in the system of the operation server 10b.

In step D4, the log obtaining unit 21 obtains logs. Thereafter, the control proceeds to step D5, and a loop end processing corresponding to step D3 is carried out. In this case, when the processing for all the devices is completed, the control proceeds to step D6.

In step D6, the log obtaining unit 21 gives logs of each device collected to the controller unit 24, and terminates the processing.

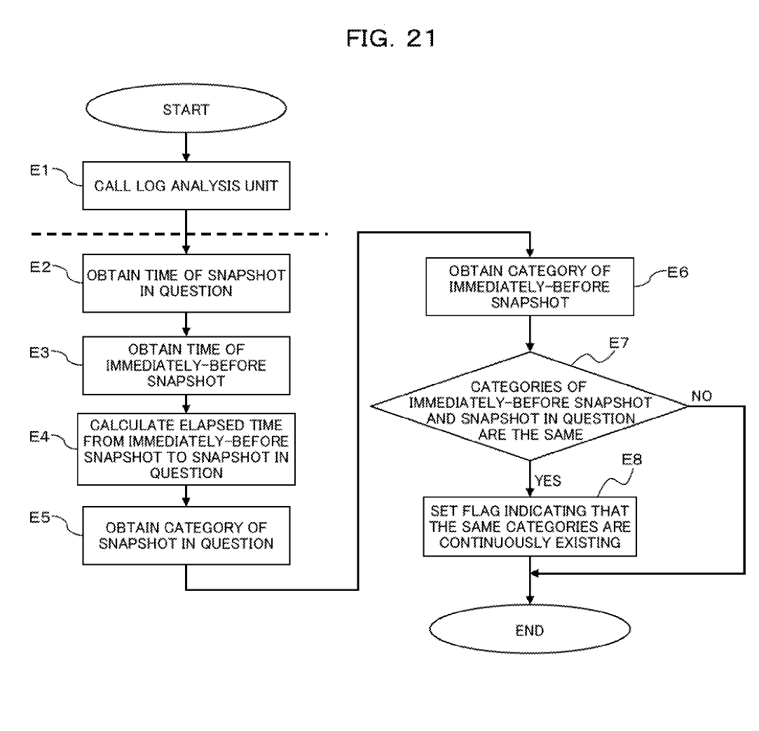

Subsequently, processing on the basis of a relationship property of multiple snapshots formed in a single virtual machine performed by the log analysis unit 22 of the information processing system 1 serving as an example of an embodiment will be explained in accordance with the flowchart (steps E1 to E8) as illustrated in FIG. 21.

In this processing, the results of the analysis (S1) to (S4) performed by the log analysis unit 22 are used.

When the log analysis unit 22 is called from the controller unit 24 in step E1, the log analysis unit 22 obtains a point in time when the snapshot of the verification target (corresponding snapshot) was obtained from the log information obtained by the log obtaining unit 21 in step E2.

In step E3, the log analysis unit 22 obtains a point in time when a snapshot was obtained before (immediately before) the snapshot of the verification target (immediately-before snapshot) was obtained.

In step E4, the log analysis unit 22 calculates an elapsed time from the immediately-before snapshot to the corresponding snapshot.

In steps E5, E6, the log analysis unit 22 obtains the categories of the corresponding snapshot and the immediately-before snapshot. Any one of the corresponding snapshot and the immediately-before snapshot may be obtained first, or the corresponding snapshot and the immediately-before snapshot may be obtained simultaneously, or the acquisition may be carried out upon making appropriate changes.

In step E7, the log analysis unit 22 determines the category of the immediately-before snapshot and the category of the corresponding snapshot are the same or not.

In a case where the category of the immediately-before snapshot and the category of the corresponding snapshot are the same as a result of the determination (see YES route in step E7), the log analysis unit 22 sets a flag indicating that the same categories continue in step E8, and terminates the processing.

In a case where the category of the immediately-before snapshot and the category of the corresponding snapshot are different as a result of the determination (see NO route in step E7), step E8 is skipped, and the processing is terminated without performing any further processing.

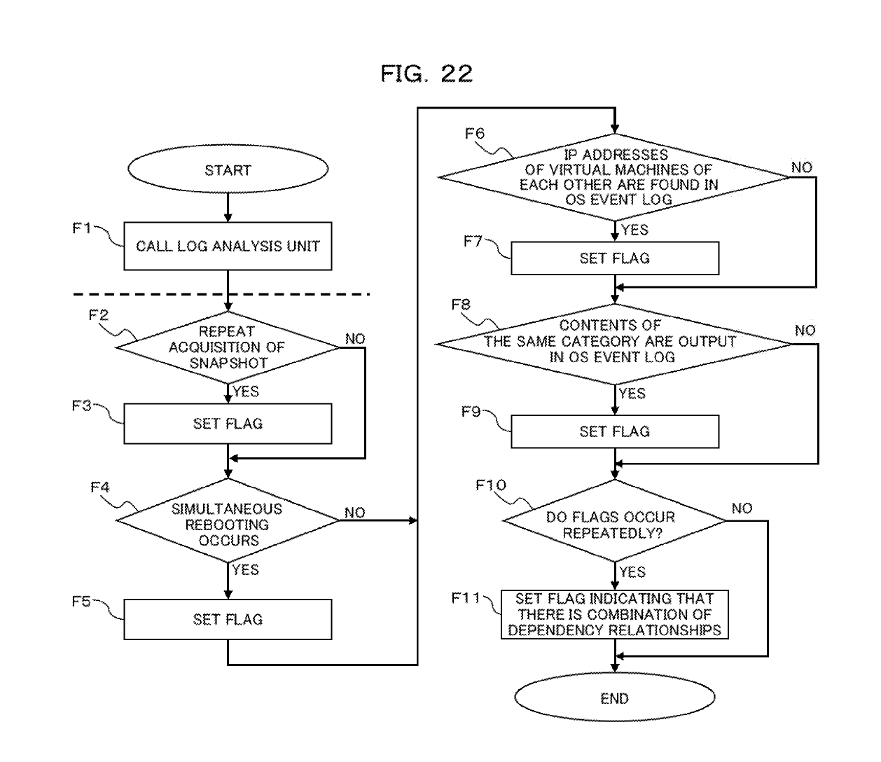

Subsequently, processing on the basis of a relationship property of multiple snapshots formed in multiple virtual machines performed by the log analysis unit 22 of the information processing system 1 serving as an example of an embodiment will be explained in accordance with the flowchart (steps F1 to F11) as illustrated in FIG. 22.

In this processing, the results of the analysis (P1) to (P4) performed by the log analysis unit 22 are used.

When the log analysis unit 22 is called from the controller unit 24 in step F1, the log analysis unit 22 performs the analysis (P1) to determine whether a combination of acquisition of snapshots in multiple virtual machines is repeatedly performed or not in step F2.

In a case where a combination of acquisition of snapshots in multiple virtual machines is not repeatedly performed (see NO route in step F2), step F3 is skipped, and step F4 is subsequently performed.

On the other hand, in a case where the log analysis unit 22 determines that a combination of acquisition of snapshots in multiple virtual machines is repeatedly detected (see YES route in step F2), step F3 is subsequently performed. In step F3, the log analysis unit 22 sets a flag indicating that acquisition of snapshot is repeatedly performed for each snapshot obtained in the acquisition of snapshots constituting the combination.

In step F4, the log analysis unit 22 performs the analysis (P2) to determine whether rebooting occurs simultaneously in multiple virtual machines or not. In a case where rebooting is not performed simultaneously in multiple virtual machines (see NO route in step F4), step F5 is skipped, and step F6 is subsequently performed.

On the other hand, in a case where rebooting occurs simultaneously in multiple virtual machines (see YES route in step F4), step F5 is subsequently performed.

In step F5, the log analysis unit 22 sets a flag indicating that rebooting occurs simultaneously in multiple virtual machines for each snapshot obtained in the acquisition of the snapshot constituting the combination of acquisition of the snapshots in multiple virtual machines.

In step F6, the log analysis unit 22 performs the analysis (P3) as to whether the IP addresses of each other are output in OS event logs (OS logs) of multiple virtual machines.

In a case where the IP addresses of each other are not output in the OS event logs in multiple virtual machines as a result of the analysis (see NO route in step F6), step F7 is skipped, and step F8 is subsequently performed.

On the other hand, in a case where the IP addresses of each other are output in the OS event logs in multiple virtual machines (see YES route in step F6), step F7 is subsequently performed.

In step F7, the log analysis unit 22 sets a flag indicating that the IP addresses of the virtual machines of each other are included in OS event logs for a snapshot obtained in each virtual machine at that point in time.

In step F8, the log analysis unit 22 performs the analysis (P4) for determining as to whether the same category contents are output in the OS event logs in multiple virtual machines (OS logs).

In a case where the same category contents are not output in the OS event logs in multiple virtual machines as a result of the analysis (see NO route in step F8), step F9 is skipped, and step F10 is subsequently performed.

On the other hand, in a case where the same category contents are output in the OS event logs in multiple virtual machines (see YES route in step F8), step F9 is subsequently performed.

In step F9, the log analysis unit 22 sets a flag indicating that the same category contents are output in the OS event logs for a snapshot obtained in each virtual machine at that point in time.

In step F10, the log analysis unit 22 determines whether the flags are set multiple times in the processing of steps F2 to F9 explained above. More specifically, the log analysis unit 22 determines whether dependency relationships occur continuously in multiple snapshots formed in multiple virtual machines.

In a case where multiple flags are not set (see NO route in step F10), the processing is terminated.

On the other hand, in a case where multiple flags are set (see YES route in step F10), the log analysis unit 22 stores a flag indicating that there is a combination of dependency relationships to a predetermined area of the storage unit 30 in step F11, and thereafter, terminates the processing.

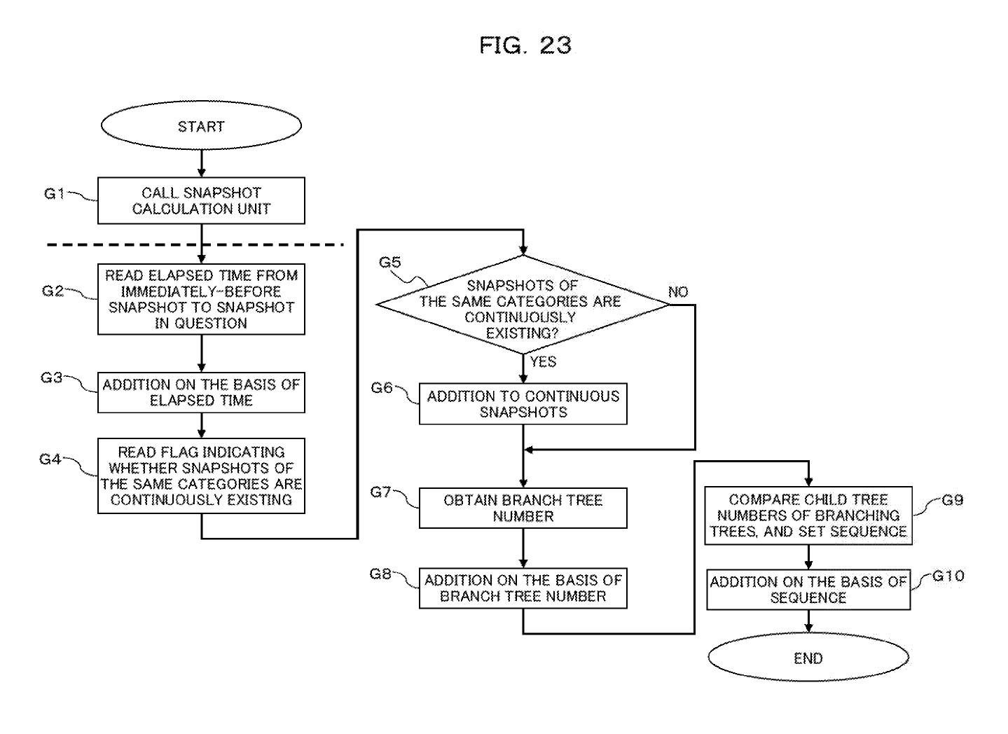

Subsequently, processing on the basis of a relationship property of multiple snapshots formed in a single virtual machine performed by the snapshot calculation unit 23 of the information processing system 1 serving as an example of an embodiment will be explained in accordance with the flowchart (steps G1 to G10) as illustrated in FIG. 23.

In this processing, the results of the analysis (S1) to (S4) performed by the log analysis unit 22 are used.

When the controller unit 24 calls the snapshot calculation unit 23 in step G1, the snapshot calculation unit 23 reads an elapsed time from the immediately-before snapshot to the corresponding snapshot calculated by the log analysis unit 22 in step G2.

In step G3, the snapshot calculation unit 23 refers to the importance level addition point table T1 on the basis of the elapsed time, thus obtaining the addition point corresponding to the elapsed time and recording it to the importance level point information T4. Accordingly, it is added to the importance level point of the snapshot.

In step G4, the snapshot calculation unit 23 checks as to whether a flag indicating that the same category continues is set by the log analysis unit 22 or not.

In step G5, the snapshot calculation unit 23 determines whether snapshots of the same category continue or not on the basis of the flag checked in step G4. In a case where snapshots of the same category are determined to continue as a result of the determination (see YES route in step G5), a point is added to the importance level point of the continuous snapshot in step G6.

Thereafter, step G7 is subsequently performed.

On the other hand, in a case where snapshots of the same category are determined not to continue (see NO route in step G5), step G6 is skipped, and step G7 is subsequently performed.

In step G7, the snapshot calculation unit 23 obtains a branch tree number calculated by the log analysis unit 22.

In step G8, the snapshot calculation unit 23 refers to the importance level addition point table T1 on the basis of the branch tree number, thus obtaining the addition point corresponding to the branch tree number and recording it to the importance level point information T4. Accordingly, it is added to the importance level point of the snapshot.

In step G9, the snapshot calculation unit 23 compares the child tree number of the branch tree, and sets the sequence in the descending order of the child tree number.

In step G10, the snapshot calculation unit 23 refers to the importance level addition point table T1 on the basis of the sequence of the child tree number, thus obtaining the addition point corresponding to the child tree number, and recording it to the importance level point information T4. Accordingly, it is added to the importance level point of the snapshot.

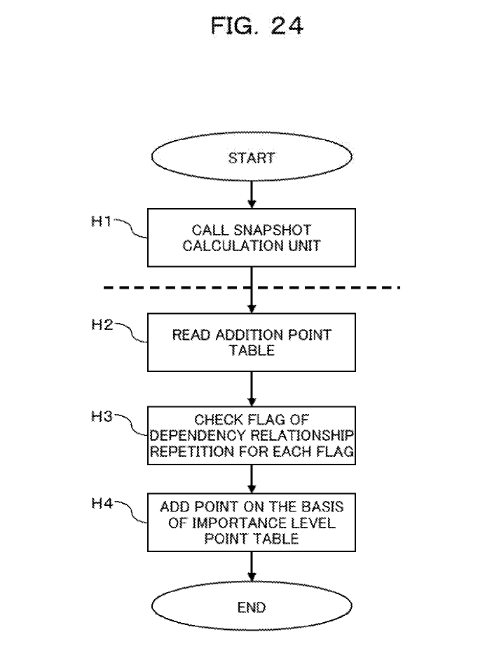

Subsequently, processing on the basis of a relationship property of multiple snapshots formed in multiple virtual machines of the snapshot calculation unit 23 of the information processing system 1 serving as an example of an embodiment will be explained in accordance with the flowchart (steps H1 to H4) as illustrated in FIG. 24.

In this processing, the results of the analysis (P1) to (P4) performed by the log analysis unit 22 are used.

When the controller unit 24 calls the snapshot calculation unit 23 in step H1, the snapshot calculation unit 23 reads the importance level addition point information T2 in step H2.

In step H3, the snapshot calculation unit 23 checks the flag which the log analysis unit 22 sets as a result of the analysis (P1) to (P4).

In step H4, the snapshot calculation unit 23 records an addition point to the importance level point information T4 on the basis of the flag that is set as a result of the analysis (P1) to (P4) by the log analysis unit 22. Accordingly, it is added to the importance level point of the snapshot.

More specifically, the snapshot calculation unit 23 refers to the importance level addition point information T2, thus obtaining an addition point corresponding to the flag and recording it to the importance level point information T4.

In a case where there are multiple flags that are set as a result of the analysis (P1) to (P4) by the log analysis unit 22, and more specifically, in a case where dependency relationships are combined, the snapshot calculation unit 23 further refers to the importance level addition point information T3, thus obtaining an addition point corresponding to the combination of the flags that have been set.

Then, the snapshot calculation unit 23 records the obtained addition point to the importance level point information T4, thus adding it to the importance level point of the snapshot.

Subsequently, processing of the snapshot operation unit 25 of the information processing system 1 serving as an example of an embodiment will be explained in accordance with the flowchart (steps K1 to K6) as illustrated in FIG. 25.

In step K1, the snapshot operation unit 25 determines whether the number of obtained snapshots has reached an upper limit value that has been set, or the IO/sec of the operation server 10b and the like has reached a lower limit value that has been set in advance.

In a case where the number of obtained snapshots has reached the upper limit value that has been set, or the IO/sec of the operation server 10b and the like has reached the lower limit value that has been set in advance (see YES route in step K1), step K2 is subsequently performed.

In step K2, the snapshot operation unit 25 reads a summation point of each snapshot of the importance level point information T4.

In step K3, the snapshot operation unit 25 sorts the snapshots registered in the importance level point information T4 in the ascending order of the summation point, and searches for a snapshot of which summation point is the lowest.

In step K4, the snapshot operation unit 25 determines whether there are multiple snapshots having the same point at the lowest summation point. In a case where there are not multiple snapshots having the same point at the lowest summation point (see NO route in step K4), more specifically, in a case where there is only one snapshot having the lowest summation point, step K6 is subsequently performed.

In a case where there are multiple snapshots having the same point at the lowest summation point (see YES route in step K4), the snapshot operation unit 25 selects the oldest snapshot from among the snapshots having the same point in step K5.

In step K6, the snapshot operation unit 25 deletes the single snapshot thus selected.

### (C) Example

Subsequently, a calculation method of an importance level point with the log analysis unit 22 and the snapshot calculation unit 23 will be explained with reference to specific examples.

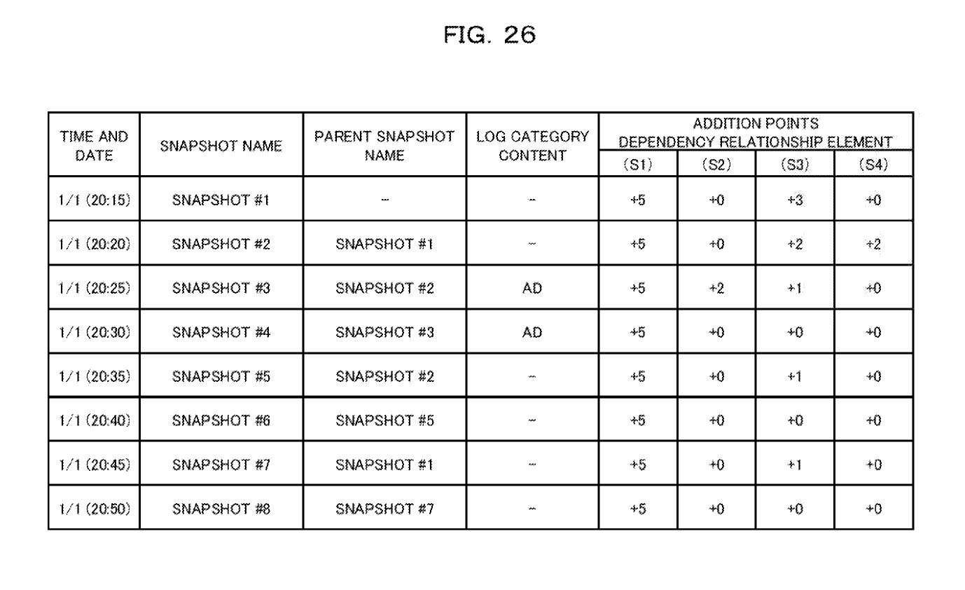

FIG. 26 is information about each snapshot constituting the snapshot tree illustrated in FIG. 8 as an example, and illustrates, for each snapshot, detailed information about each of them and an addition point determined by the snapshot calculation unit 23.

In the example as illustrated in FIG. 26, for example, both of the snapshot #3 and the snapshot #4 are obtained before performing structuring work of categories with regard to AD (Active Directory: registered trademark) of Microsoft Corporation.

The log analysis unit 22 performs the analysis (S1) to (S4) on the basis of the information. The snapshot calculation unit 23 refers to the importance level addition point information T1 on the basis of the analysis result, and determines an addition point for each snapshot as illustrated in FIG. 26.

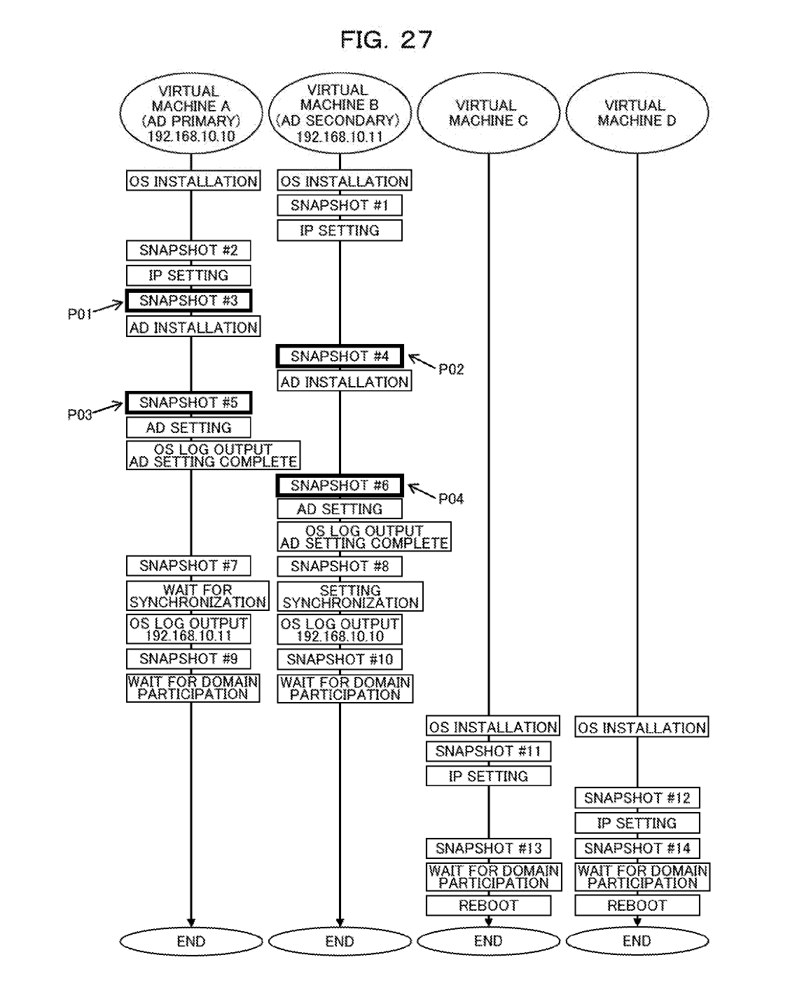

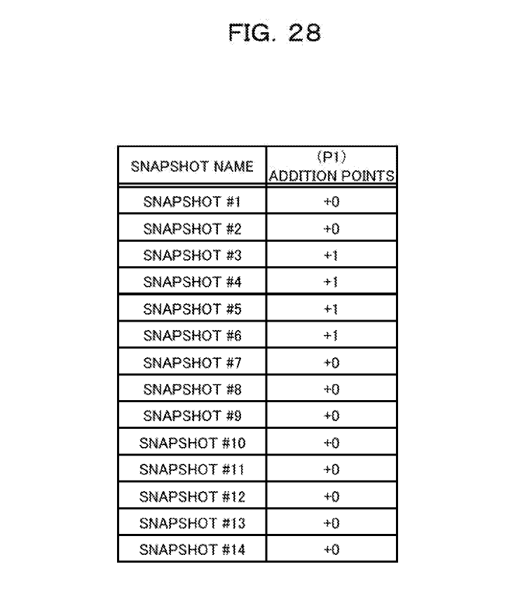

FIG. 27 is a sequence diagram illustrating an example where acquisition of snapshots is repeated in multiple virtual machines. FIG. 28 is a figure illustrating an example of addition points that are set for snapshots on the basis of dependency relationships read from FIG. 27.

The example as illustrated in FIG. 27 illustrates each processing in the virtual machines A, B, C, D, and the snapshot #3 is obtained in the virtual machine A (see reference symbol P01), and in a predetermined period of time after that, the snapshot #4 is obtained in the virtual machine B (reference symbol P02).

Thereafter, in the virtual machine A, after the installation work of the AD is performed, the snapshot #5 is obtained (see reference symbol P03).

In the virtual machine B, in a predetermined period of time after the snapshot #5 was obtained in the virtual machine A, the snapshot #6 is obtained (see reference symbol P04).

More specifically, a combination in which a snapshot (#3, #5) is obtained in the virtual machine A and thereafter a snapshot (#4, #6) is obtained in the virtual machine B is repeatedly performed (see reference symbols P01 to P04).

The log analysis unit 22 determines that there is a dependency relationship between the snapshot #3 obtained in the virtual machine A and the snapshot #4 obtained in the virtual machine B. Likewise, the log analysis unit 22 determines that there is a dependency relationship between the snapshot #5 obtained in the virtual machine A and the snapshot #6 obtained in the virtual machine B. As a result, with regard to the snapshots #3 to #6, the log analysis unit 22 repeatedly detects a combination of acquisition of snapshots in multiple virtual machines, and sets a flag indicating that there is a dependency relationship.

As illustrated in FIG. 28, the snapshot calculation unit 23 refers to the importance level addition point information T2 to set an addition point (+1) for the snapshots #3 to #6 for which the flags have been set by the log analysis unit 22 as described above.

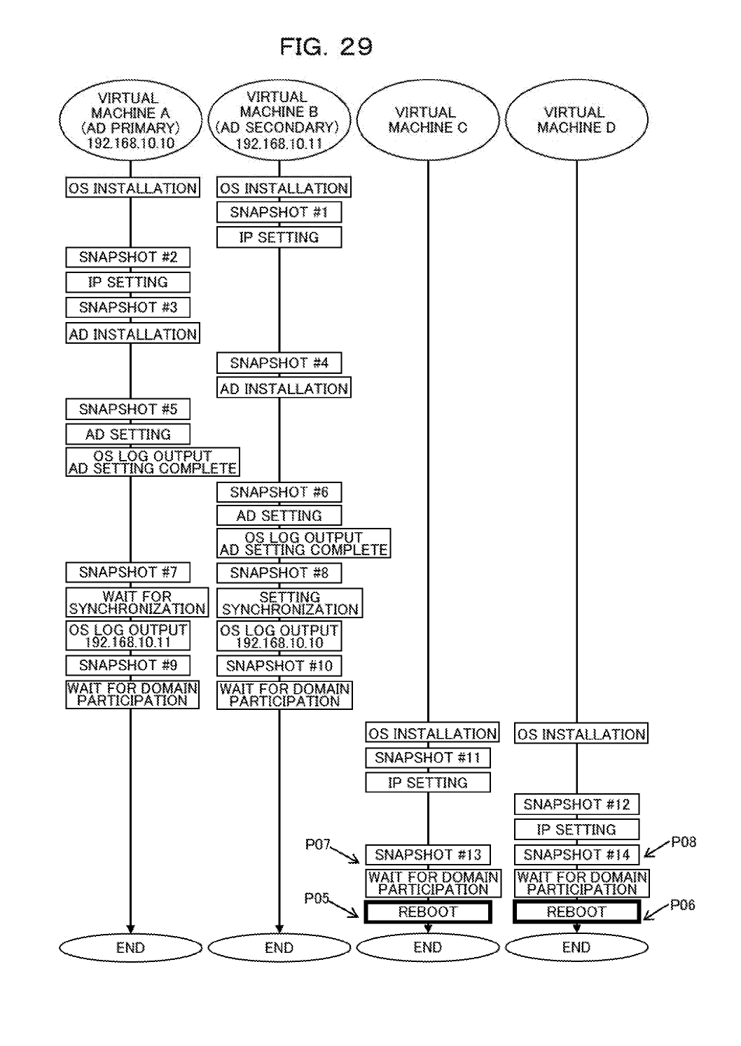

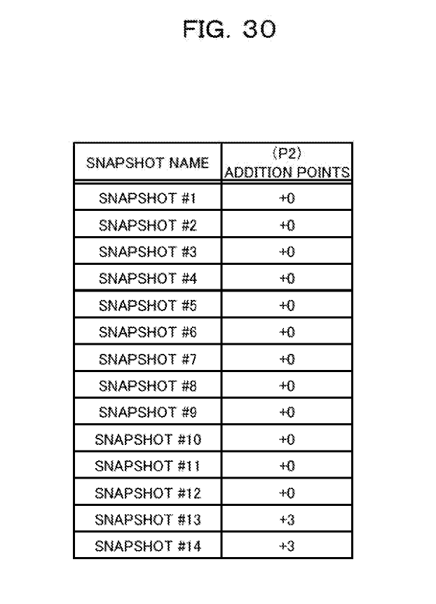

FIG. 29 is a sequence diagram illustrating an example where rebooting is simultaneously performed in multiple virtual machines. FIG. 30 is a figure illustrating an example of addition points that are set for snapshots on the basis of dependency relationships read from FIG. 29.

The example as illustrated in FIG. 29 illustrates each processing in the virtual machines A, B, C, D, and a virtual machine C and a virtual machine D are rebooted simultaneously (see reference symbols P05, P06).

In the virtual machine C, the snapshot #13 is obtained before rebooting is performed (see reference symbol P07), and in the virtual machine D, the snapshot #14 is obtained before rebooting is performed (see reference symbol P08).

The log analysis unit 22 detects that the virtual machines C, D are simultaneously rebooted, and determines that there is a dependency relationship in the snapshot #13 obtained in the virtual machine C and the snapshot #14 obtained in the virtual machine D obtained before the rebooting. As a result, the log analysis unit 22 sets a flag indicating that rebooting is performed simultaneously and that there is a dependency relationship for these snapshots #13, #14.

As illustrated in FIG. 30, the snapshot calculation unit 23 refers to the importance level addition point information T2 to set an addition point (+3) for the snapshots #13, #14 for which the flags have been set by the log analysis unit 22 as described above.

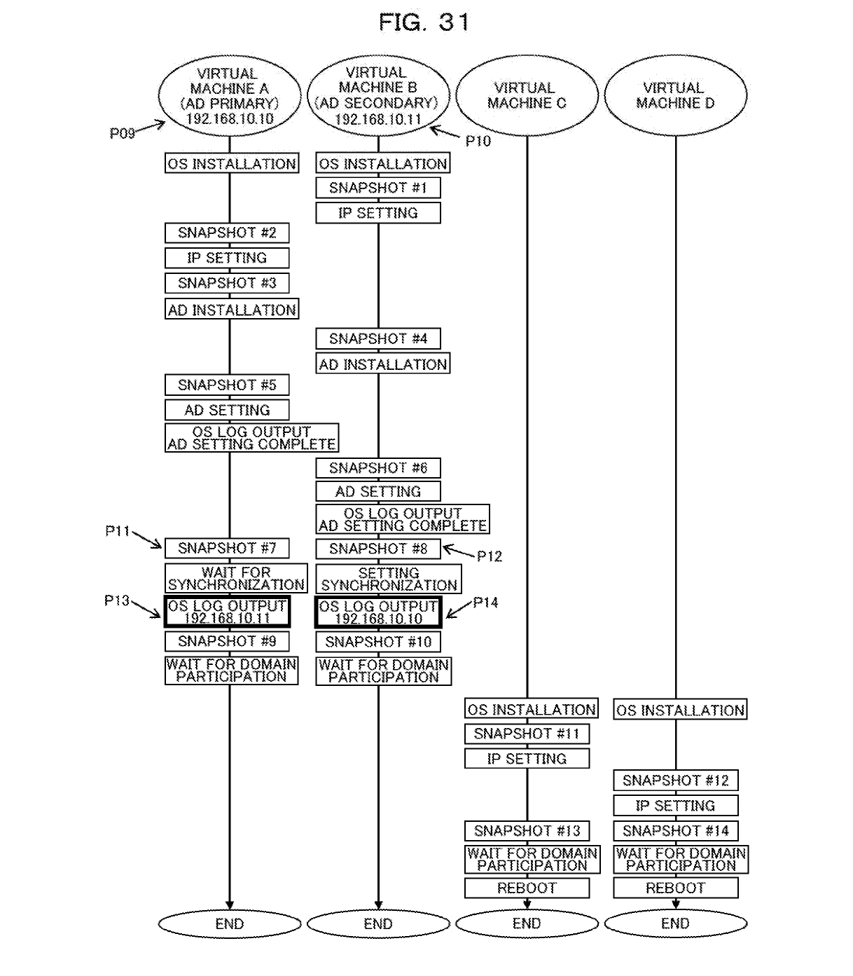

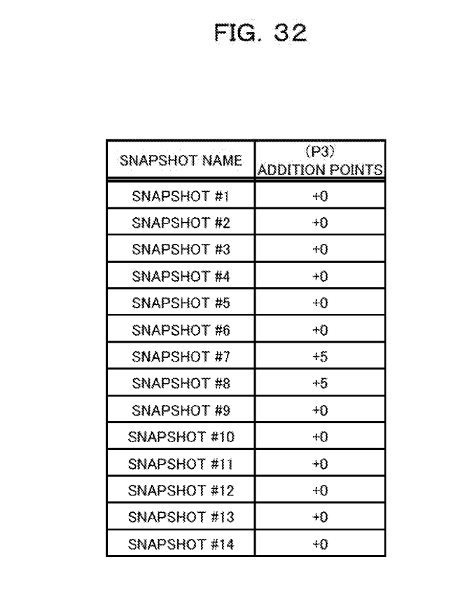

FIG. 31 is a sequence diagram illustrating an example where the IP addresses of each other are output in OS event logs of multiple virtual machines. FIG. 32 is a figure illustrating an example of addition points that are set for snapshots on the basis of dependency relationships read from FIG. 31.

The example as illustrated in FIG. 31 illustrates each processing in the virtual machines A, B, C, D, and the IP address of the virtual machine A is “192.168.10.10” (see reference symbol P09), and the IP address of the virtual machine B is “192.168.10.11” (see reference symbol P10).

Then, in the virtual machine A, synchronization waiting is performed after the snapshot #7 (see reference symbol P11) is obtained, and thereafter an OS log output is performed. The IP address of the virtual machine B “192.168.10.11 is included in the OS log output that is output in the virtual machine A (see reference symbol P13).

On the other hand, in the virtual machine B, synchronization waiting is performed after the snapshot #8 (see reference symbol P12) is obtained, and thereafter an OS log output is performed. The IP address of the virtual machine A “192.168.10.10” is included in the OS log output that is output in the virtual machine B (see reference symbol P14).

Since the IP addresses of each other are included in the OS event logs obtained in the virtual machines A, B, the log analysis unit 22 determines that there is a dependency relationship in the snapshot #7 obtained in the virtual machine A and the snapshot #8 obtained in the virtual machine B obtained before the OS log output.

As a result, the log analysis unit 22 sets a flag indicating that the IP addresses of the virtual machines of each other are included in OS event logs for the snapshots #7, #8.

As illustrated in FIG. 32, the snapshot calculation unit 23 refers to the importance level addition point information T2 to set an addition point (+5) for the snapshots #7, #8 for which the flags have been set by the log analysis unit 22 as described above.

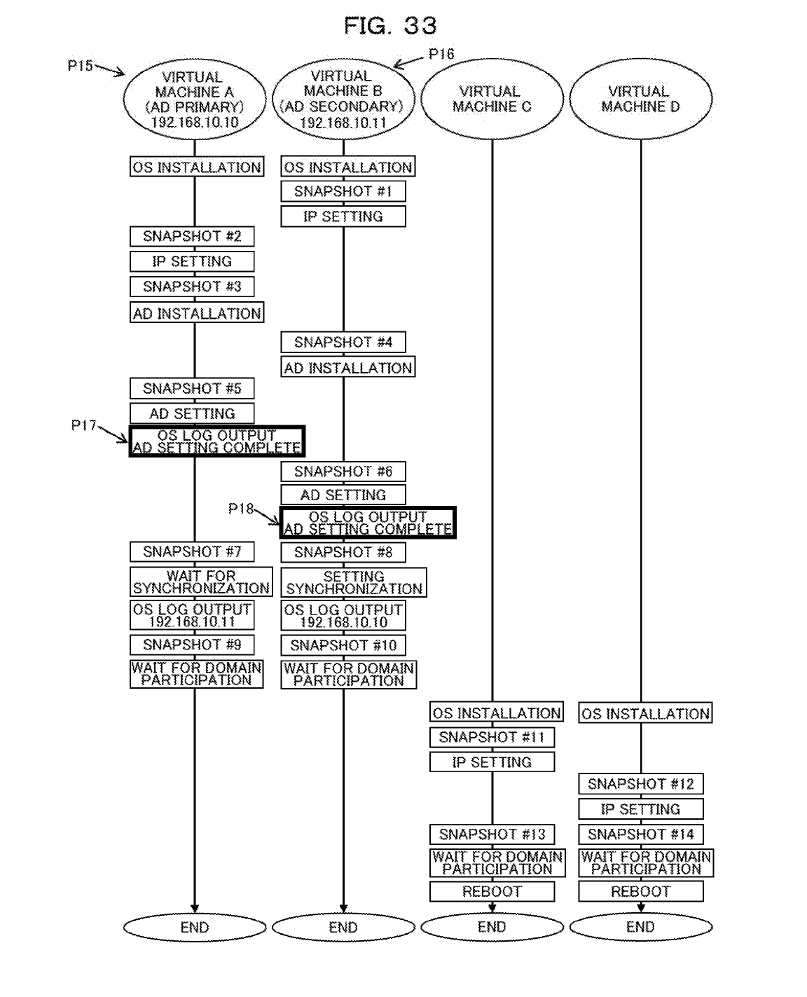

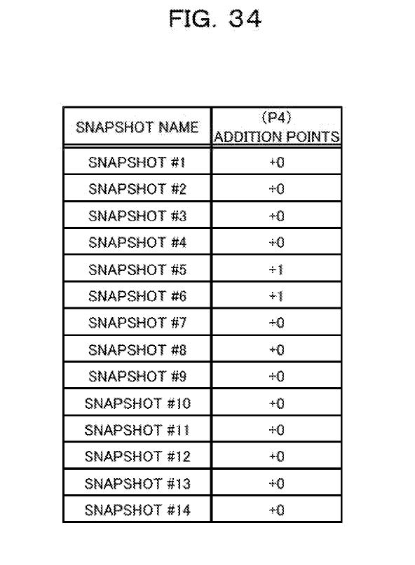

FIG. 33 is a sequence diagram illustrating an example where the same category contents are included in OS event logs in multiple virtual machines. FIG. 34 is a figure illustrating an example of addition points that are set for snapshots on the basis of dependency relationships read from FIG. 33.

The example as illustrated in FIG. 33 illustrates each processing in the virtual machines A, B, C, D, and the virtual machine A functions as a primary server of AD (see reference symbol P15). The virtual machine B functions as a secondary server of AD (see reference symbol P16).

Then, “AD setting completion” is output in the OS event log that is output in the virtual machine A (see reference symbol P17).

On the other hand, “AD setting completion” is also output in the OS event log that is output in the virtual machine B (see reference symbol P18).

Since “AD setting completion”, i.e., the same category contents, is included in the OS event log obtained in the virtual machines A, B, the log analysis unit 22 determines that there is a dependency relationship in the snapshot #5 obtained in the virtual machine A and the snapshot #6 obtained in the virtual machine B obtained before the OS log output.

As a result, the log analysis unit 22 sets a flag indicating that the identical category contents are output in the OS event logs for the snapshots #5, #6.

As illustrated in FIG. 34, the snapshot calculation unit 23 refers to the importance level addition point information T2 to set an addition point (+1) for the snapshots #5, #6 for which the flags have been set by the log analysis unit 22 as described above.

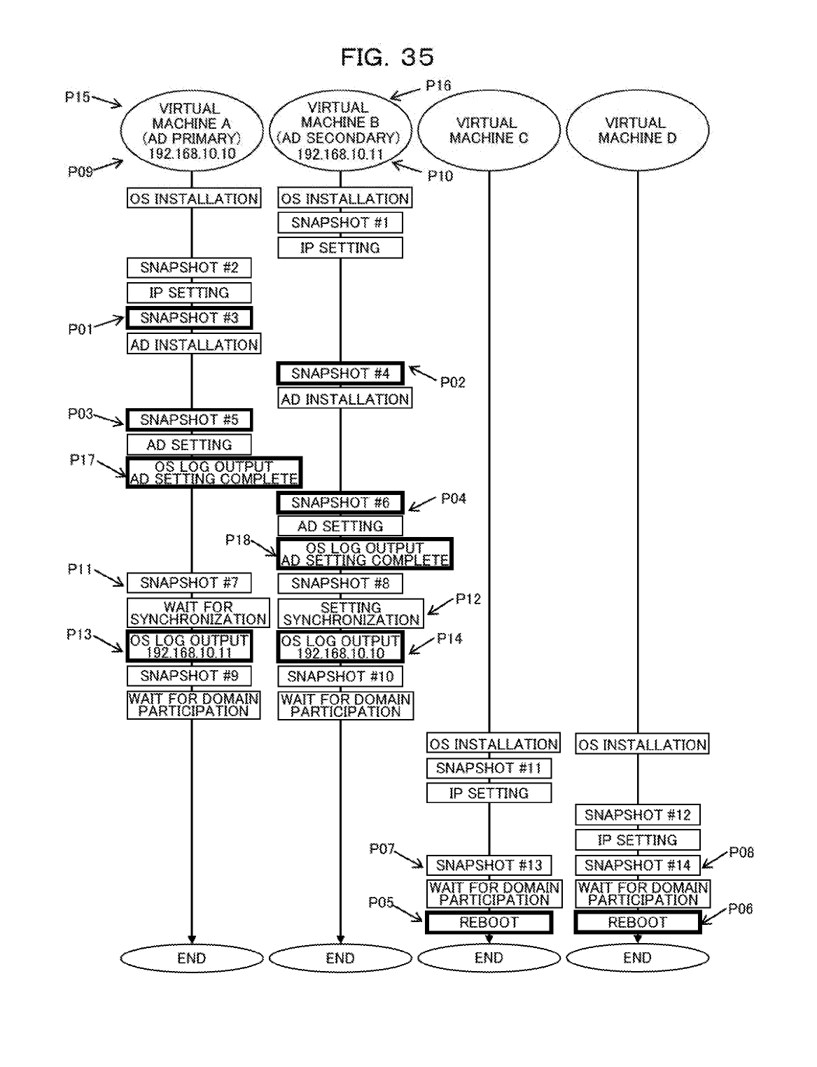

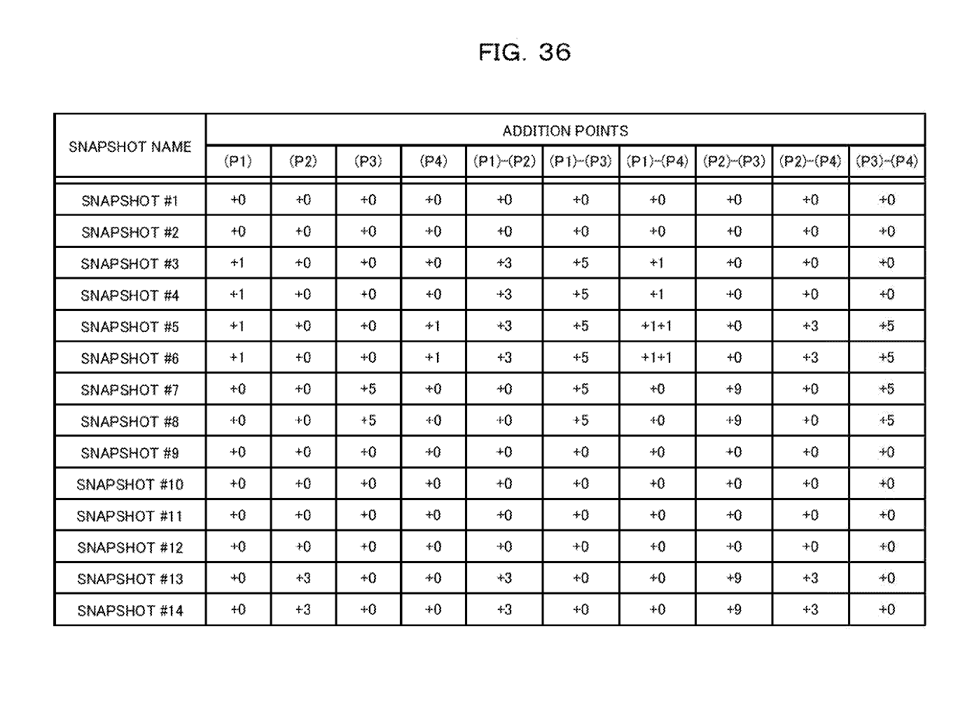

FIG. 35 is a sequence diagram illustrating an example where multiple dependency relationships are detected continuously in multiple virtual machines. FIG. 36 is a figure illustrating an example of addition points that are set for snapshots on the basis of dependency relationships read from FIG. 35.

Like FIG. 27, FIG. 29, FIG. 31, FIG. 33, the example as illustrated in FIG. 35 illustrates each processing in the virtual machines A, B, C, D. In the drawings, the same reference symbols as the above reference symbols represent similar contents, and detailed explanation thereabout is omitted.

More specifically, in the example as illustrated in FIG. 35, a combination in which a snapshot (#3, #5) is obtained in the virtual machine A and thereafter a snapshot (#4, #6) is obtained in the virtual machine B is repeatedly performed (see reference symbols P01 to P04).

The virtual machine C and the virtual machine D are simultaneously rebooted (see reference symbols P05, P06).

The IP addresses of each other are included in the OS event logs obtained in the virtual machines A, B (see reference symbols P13, P14).

“AD setting completion”, i.e., the same category contents, are included in the OS event logs obtained in the virtual machines A, B (see reference symbols P17, P18).

Therefore, in the example as illustrated in FIG. 35, the dependency relationship is satisfied for all the analysis (P1) to (P4) explained above.

As illustrated in FIG. 36, the snapshot calculation unit 23 sets addition points for the analysis (P1) to (P4), and sets addition points for each of the combinations of (P1)-(P2), (P1)-(P3), (P1)-(P4), (P2)-(P3), (P2)-(P4) and (P3)-(P4).

The snapshot calculation unit 23 refers to the importance level addition point information T1 to derive the addition point for each snapshot on the basis of the analysis (S1) to (S4) performed by the log analysis unit 22.

The snapshot calculation unit 23 refers to the importance level addition point information T2 to derive the addition point for each snapshot on the basis of results of the analysis (P1) to (P4) performed by the log analysis unit 22.

Further, in a case where multiple dependency relationships between snapshots obtained in multiple virtual machines are detected continuously, the snapshot calculation unit 23 refers to the importance level addition point information T3 to derive the addition point for each snapshot for a corresponding result of the combination of the analysis (P1) to (P4) performed by the log analysis unit 22.

The snapshot calculation unit 23 sets the addition points thus derived into the importance level point information T4, adds the addition points for each snapshot, and calculates the importance level point.

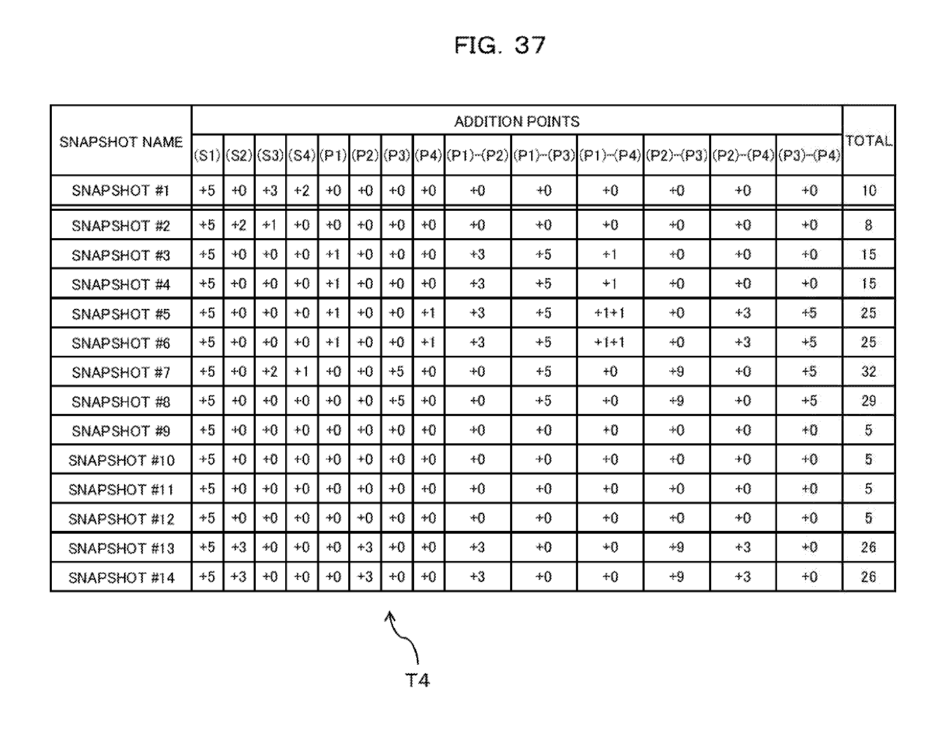

FIG. 37 is a figure illustrating an example of the importance level point information T4. The snapshot operation unit 25 sorts the snapshots registered in the importance level point information T4 in the ascending order of the summation point.

The snapshot operation unit 25 first selects, as a deletion target, a snapshot of which summation point (importance level point) is the lowest in the importance level point information T4, and selects snapshots accordingly in the order of the summation point (importance level point).

In this case, in the importance level point information T4 as illustrated in FIG. 37 as an example, the importance level point of the snapshots #9 to #12 is 5, which is the smallest.

As described above, in a case where there are multiple snapshots of which importance level points are the smallest, the snapshot operation unit 25 preferentially deletes a snapshot of these multiple snapshots, whichever the time of acquisition is the oldest.

Therefore, the snapshot operation unit 25 preferentially deletes the snapshot #9 of which time of acquisition is the oldest from among the snapshots #9 to #12 of which importance level points are the smallest.

### (D) Effects

As described above, in the information processing system 1 serving as an example of an embodiment, the log analysis unit 22 and snapshot calculation unit 23 sets importance level points indicating importance levels for multiple snapshots.

Accordingly, the importance levels of multiple snapshots can be easily found.

The snapshot operation unit 25 deletes, in order, those of the multiple snapshots of which importance level points are smaller, and more specifically, the snapshot operation unit 25 first deletes a snapshot of which importance level is the lowest, and accordingly, the snapshot operation unit 25 deletes the snapshots of which importance levels are lower in order.

Therefore, an erroneous operation, in which a worker deletes a snapshot which is not to be deleted by mistake, can be prevented.

In this information processing system 1, a snapshot having a lower importance level point is less related to other snapshots, and therefore, the effect caused on the other snapshots and virtual machines can be reduced by preferentially deleting a snapshot of which importance level point is lower. Therefore, snapshots can be deleted efficiently. The system can be caused to operate stably.

In this information processing system 1, the log analysis unit 22 and the snapshot calculation unit 23 set the importance levels of snapshots on the basis of relationship between multiple snapshots.

A dependency relationship between snapshots is generated, and importance levels of snapshots of each virtual machine are determined on the basis of this, so that snapshots, to which the virtual machine is to roll back, is not deleted by mistake, and therefore, useless repetition of works can be prevented.

### (E) Others

The disclosed techniques are not limited to the above embodiment, and can be carried out by applying various modifications within a range not deviating from the gist of the present embodiment. Each configuration and each processing of the present embodiment can be selected and discarded, or may be combined.

For example, in the above embodiment, the management server 10a and the operation server 10b are not provided as separate computers, but the embodiment is not limited thereto, and can be carried out upon applying various modifications. For example, the operation server 10b may have the function for the management server 10a. The functions of the management server 10a may be provided in multiple computers in a distributed manner.

In the above embodiment, with regard to the analysis (S2) of the operation content during the acquisition of snapshot, the log analysis unit 22 sets a higher importance level for the snapshot obtained immediately before the first structuring work of multiple structuring works of the same category, but the embodiment is not limited thereto.

For example, an importance level point may be added to not only the snapshot obtained immediately before the first structuring work but also each snapshot obtained with regard to each structuring work performed multiple times, so that the importance level may be raised.

The present embodiment may be carried out and produced by a person skilled in the art on the basis of the above disclosure.

According to an embodiment, a snapshot of multiple snapshots of which importance level is lower can be easily determined.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A management apparatus for managing a plurality of snapshots stored in a storage apparatus,
the management apparatus comprising:
a determination unit configured to determine a relationship state between the plurality of snapshots;
a setting unit configured to set importance level information for each snapshot on the basis of the relationship state determined; and
a deletion processing unit configured to preferentially delete a snapshot of which importance level information is the lowest.

2. The management apparatus according to claim 1, wherein the determination unit determines the relationship state on the basis of a relationship property of the plurality of snapshots obtained in a virtual machine.

3. The management apparatus according to claim 2, wherein the setting unit sets higher importance level information for a previous snapshot of the plurality of snapshots when an elapsed time from a point in time when the previous snapshot is obtained to a point in time when a snapshot subsequent to the previous snapshot is obtained is longer.

4. The management apparatus according to claim 2, wherein, in a case where a plurality of works of a same type are performed, the setting unit sets higher importance level information for a snapshot of the plurality of snapshots that is obtained immediately before the plurality of works.

5. The management apparatus according to claim 2, wherein the setting unit sets importance level information for a snapshot of the plurality of snapshots in accordance with a number of snapshots connected at a lower position of the snapshot in a snapshot tree configuration formed by connecting the plurality of snapshots in a tree form.

6. The management apparatus according to claim 2, wherein the setting unit sets importance level information for a snapshot of the plurality of snapshots in accordance with a number of branches of a snapshot tree at a lower position of the snapshot in a snapshot tree configuration formed by connecting the plurality of snapshots in a tree form.

7. The management apparatus according to claim 1, wherein the determination unit determines the relationship state on the basis of a relationship property of the plurality of snapshots obtained in each of a plurality of virtual machines.

8. The management apparatus according to claim 7, wherein in a case where a combination of acquisition of a snapshot of the plurality of snapshots in a first virtual machine, which is one of the plurality of virtual machines, and acquisition of a snapshot of the plurality of snapshots in a second virtual machine, which is one of the plurality of virtual machines, is executed repeatedly by the first virtual machine and the second virtual machine, the determination unit determines that a snapshot of the plurality of snapshots obtained in the first virtual machine and a snapshot of the plurality of snapshots obtained in the second virtual machine, which constitute the combination, are in the relationship state, and
the setting unit sets high importance level information for the snapshot obtained in the first virtual machine and the snapshot obtained in the second virtual machine which are determined to be in the relationship state.

9. The management apparatus according to claim 7, wherein in a case where a reboot processing is performed after acquisition of a snapshot of the plurality of snapshots is performed by each of the first virtual machine of the plurality of virtual machines and the second virtual machine of the plurality of virtual machines, the determination unit determines that the snapshot obtained in the first virtual machine before the reboot processing and the snapshot obtained in the second virtual machine before the reboot processing are in the relationship state, and
the setting unit sets high importance level information for the snapshot obtained in the first virtual machine and the snapshot obtained in the second virtual machine which are determined to be in the relationship state.

10. The management apparatus according to claim 7, wherein in a case where identification information for identifying the second virtual machine, which is one of the plurality of virtual machines, is detected in log information obtained in the first virtual machine, which is one of the plurality of virtual machines, and identification information for identifying the first virtual machine is detected in log information obtained in the second virtual machine, the determination unit determines that a snapshot of the plurality of snapshots that is obtained in the first virtual machine during acquisition of the log information and a snapshot of the plurality of snapshots that is obtained in the second virtual machine during acquisition of the log information are in the relationship state, and
the setting unit sets high importance level information for the snapshot obtained in the first virtual machine and the snapshot obtained in the second virtual machine which are determined to be in the relationship state.

11. The management apparatus according to claim 7, wherein in a case where information about same processing is detected in log information obtained in the first virtual machine, which is one of the plurality of virtual machines, and log information obtained in the second virtual machine, which is one of the plurality of virtual machines, the determination unit determines that the snapshot which is one of the plurality of snapshots and which is obtained in the first virtual machine during acquisition of the log information and the snapshot which is one of the plurality of snapshots and which is obtained in the second virtual machine during acquisition of the log information are in the relationship state, and
the setting unit sets high importance level information for the snapshot obtained in the first virtual machine and the snapshot obtained in the second virtual machine, which are determined to be in the relationship state.

12. A management method for managing a plurality of snapshots stored in a storage apparatus, the management method comprising:
determining a relationship state between the plurality of snapshots;
setting importance level information for each snapshot on the basis of the relationship state determined; and
preferentially deleting a snapshot of which importance level information is the lowest.

13. The management method according to claim 12, wherein the relationship state is determined on the basis of a relationship property of the plurality of snapshots obtained in a virtual machine.

14. The management method according to claim 12, wherein the relationship state is determined on the basis of a relationship property of the plurality of snapshots obtained in each of a plurality of virtual machines.

15. A computer-readable non-transitory recording medium recorded with a management program for causing a processor of a management apparatus managing a plurality of snapshots stored in a storage apparatus to execute processing of:
determining a relationship state between the plurality of snapshots;
setting importance level information for each snapshot on the basis of the relationship state determined; and
preferentially deleting a snapshot of which importance level information is the lowest.

16. The computer-readable recording non-transitory medium recorded with the management program according to claim 15, causing the processor to execute processing of determining the relationship state on the basis of a relationship property of the plurality of snapshots obtained in a virtual machine.

17. The computer-readable non-transitory recording medium recorded with the management program according to claim 15, causing the processor to execute processing of determining the relationship state on the basis of a relationship property of the plurality of snapshots obtained in each of a plurality of virtual machines.
